(19) United States
(12) Patent Application Publication
(10) Pub. No.: US 2025/0106292 A1
(43) Pub. Date: Mar. 27, 2025

(54) PROTOCOL DATA UNIT SESSION ESTABLISHMENT VIA USER PLANE SIGNALING

(71) Applicant: QUALCOMM Incorporated, San Diego, CA (US)

(72) Inventors: Karl Georg HAMPEL, Jersey City, NJ (US); Naeem AKL, BRIDGEWATER, NJ (US); Miguel GRIOT, La Jolla, CA (US)

(21) Appl. No.: 18/474,980

(22) Filed: Sep. 26, 2023

(51) Int. Cl. H04L 67/14; H04W 76/11; H04W 76/12

(52) U.S. Cl. CPC H04L 67/14; H04W 76/11; H04W 76/12

(57) ABSTRACT

Methods, systems, and devices for wireless communication are described. A user equipment (UE) may receive first information indicative of a first internet protocol address. The UE may transmit a non-access stratum (NAS) request to a core network service to establish a protocol data unit session using the first internet protocol address and a user plane protocol stack. The UE may receive, from the core network service using the first internet protocol address and the user plane protocol stack, a NAS response including second information indicative of a second internet protocol address. The UE may transmit NAS information to the core network service using the first internet protocol address and the user plane protocol stack, and first data information associated with the protocol data unit session using the second internet protocol address and the user plane protocol stack.

### TECHNICAL FIELD

The following relates to wireless communication, including protocol data unit (PDU) session establishment via user plane signaling.

### DESCRIPTION OF THE RELATED TECHNOLOGY

Wireless communication systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communication system may include one or more base stations, each supporting wireless communication for communication devices, which may be known as user equipment (UE).

In some wireless communication systems, a user equipment (UE) may use separate protocol stacks to communicate data traffic with a data network and to communicate non-access stratum (NAS) traffic with a core network. In these cases, the connectivity to the data network is based on a protocol data unit (PDU) session between the UE and, for example, a user plane function (UPF) of the core network. The PDU session is established, however, via the NAS traffic meaning that the NAS traffic is a prerequisite for the PDU session. In these cases, the UE, among other wireless communication devices, does not support using a single protocol stack for both the data traffic and the NAS traffic.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications by a user equipment (UE). The method includes receiving first information indicative of a first internet protocol (IP) address, transmitting a non-access stratum (NAS) request that indicates the first IP address to a core network service to establish a protocol data unit (PDU) session using a user plane protocol stack, receiving, from the core network service using the user plane protocol stack, a NAS response that indicates the first IP address, the NAS response including second information indicative of a second IP address, and transmitting NAS information that indicates the first IP address to the core network service using the user plane protocol stack, and first data information associated with the PDU session that indicates the second IP address using the user plane protocol stack.

Another innovative aspect of the subject matter described in this disclosure can be implemented in a UE for wireless communications. The UE includes a processing system that includes processor circuitry and memory circuitry that stores code. The processing system configured to cause the UE to receive first information indicative of a first IP address, transmit a NAS request that indicates the first IP address to a core network service to establish a PDU session using a user plane protocol stack, receive, from the core network service using the user plane protocol stack, a NAS response that indicates the first IP address, the NAS response including second information indicative of a second IP address, and transmit NAS information that indicates the first IP address to the core network service using the user plane protocol stack, and first data information associated with the PDU session that indicates the second IP address using the user plane protocol stack.

Another innovative aspect of the subject matter described in this disclosure can be implemented in a UE for wireless communications. The UE includes means for receiving first information indicative of a first IP address, means for transmitting a NAS request that indicates the first IP address to a core network service to establish a PDU session using a user plane protocol stack, means for receiving, from the core network service using the user plane protocol stack, a NAS response that indicates the first IP address, the NAS response including second information indicative of a second IP address, and means for transmitting NAS information that indicates the first IP address to the core network service using the user plane protocol stack, and first data information associated with the PDU session that indicates the second IP address using the user plane protocol stack.

Another innovative aspect of the subject matter described in this disclosure can be implemented in a non-transitory computer-readable medium storing code for wireless communications. The code includes instructions executable by one or more processors to receive first information indicative of a first IP address, transmit a NAS request that indicates the first IP address to a core network service to establish a PDU session using a user plane protocol stack, receive, from the core network service using the user plane protocol stack, a NAS response that indicates the first IP address, the NAS response including second information indicative of a second IP address, and transmit NAS information that indicates the first IP address to the core network service using the user plane protocol stack, and first data information associated with the PDU session that indicates the second IP address using the user plane protocol stack.

Another innovative aspect of the subject matter described in this disclosure can be implemented in a method for wireless communications by a network node. The method includes transmitting first information indicative of a first IP address to a UE, receiving, from the UE using a user plane protocol stack, a first PDU including the first IP address, transmitting, to the UE, a second PDU including the first IP address, receiving, from a core network entity, a second IP address and session tunnel information for a session tunnel for the UE, and receiving, from the UE using the user plane protocol stack, a third PDU including the second IP address.

Another innovative aspect of the subject matter described in this disclosure can be implemented in a network node for wireless communications. The network node may include a processing system that includes processor circuitry and memory circuitry that stores code. The processing system may be configured to cause the network node to transmit first information indicative of a first IP address to a UE, receive, from the UE using a user plane protocol stack, a first PDU including the first IP address, transmit, to the UE, a second PDU including the first IP address, receive, from a core network entity, a second IP address and session tunnel information for a session tunnel for the UE, and receive, from the UE using the user plane protocol stack, a third PDU including the second IP address.

Another innovative aspect of the subject matter described in this disclosure can be implemented in a network node for wireless communications. The network node may include means for transmitting first information indicative of a first IP address to a UE, means for receiving, from the UE using a user plane protocol stack, a first PDU including the first IP address, means for transmitting, to the UE, a second PDU including the first IP address, means for receiving, from a core network entity, a second IP address and session tunnel information for a session tunnel for the UE, and means for receiving, from the UE using the user plane protocol stack, a third PDU including the second IP address.

Another innovative aspect of the subject matter described in this disclosure can be implemented in a non-transitory computer-readable medium storing code for wireless communications is described. The code may include instructions executable by one or more processors to transmit first information indicative of a first IP address to a UE, receive, from the UE using a user plane protocol stack, a first PDU including the first IP address, transmit, to the UE, a second PDU including the first IP address, receive, from a core network entity, a second IP address and session tunnel information for a session tunnel for the UE, and receive, from the UE using the user plane protocol stack, a third PDU including the second IP address.

### BRIEF DESCRIPTION OF THE DRAWINGS

FIG. 1 shows an example of a wireless communication system that supports protocol data unit (PDU) session establishment via user plane signaling in accordance with one or more aspects of the present disclosure.

FIG. 2 shows an example of a wireless communication system that supports PDU session establishment via user plane signaling in accordance with one or more aspects of the present disclosure.

FIG. 3 shows an example of a protocol stack that supports PDU session establishment via user plane signaling in accordance with one or more aspects of the present disclosure.

FIG. 4 shows an example of a process flow that supports PDU session establishment via user plane signaling in accordance with one or more aspects of the present disclosure.

FIG. 5 shows an example of a process flow that supports PDU session establishment via user plane signaling in accordance with one or more aspects of the present disclosure.

FIGS. 6 and 7 show block diagrams of devices that support PDU session establishment via user plane signaling in accordance with one or more aspects of the present disclosure.

FIG. 8 shows a block diagram of a communication manager that supports PDU session establishment via user plane signaling in accordance with one or more aspects of the present disclosure.

FIG. 9 shows a diagram of a system including a device that supports PDU session establishment via user plane signaling in accordance with one or more aspects of the present disclosure.

FIGS. 10 and 11 show block diagrams of devices that support PDU session establishment via user plane signaling in accordance with one or more aspects of the present disclosure.

FIG. 12 shows a block diagram of a communication manager that supports PDU session establishment via user plane signaling in accordance with one or more aspects of the present disclosure.

FIG. 13 shows a diagram of a system including a device that supports PDU session establishment via user plane signaling in accordance with one or more aspects of the present disclosure.

FIGS. 14-17 show flowcharts illustrating methods that support PDU session establishment via user plane signaling in accordance with one or more aspects of the present disclosure.

### DETAILED DESCRIPTION

In some wireless communication systems, a user equipment (UE) may use separate protocol stacks as part of other different techniques to communicate data traffic with a data network and to communicate non-access stratum (NAS) signaling with a core network. Connectivity to the data network in these systems may include having a protocol data unit (PDU) session established between the UE and a user plane function (UPF), for example, and the PDU session may be established via NAS signaling. But these other different techniques do not support using a single protocol stack for both data traffic with a data network and NAS traffic with a core network. In contrast, wireless communication systems described herein can support using a single protocol stack (instead of the separate protocol stacks) to communicate both data traffic with a data network and NAS traffic with a core network.

Various aspects generally relate to PDU session establishment, and more specifically, to using a common user plane protocol stack for data traffic to a data network and NAS traffic to a core network. A network entity, such as a sixth generation (6G) base station, may support an internet protocol (IP) router function to a backhaul IP network. The network entity may transmit a first IP address to a UE over a wireless channel, and the first IP address may be associated with a subnet of network entities and core network services on a backhaul IP network, including the network entity. The UE may use the first IP address and the user plane protocol stack to transmit a NAS request to a core network service to establish a PDU session with the data network. For example, the UE may transmit the NAS request indicating the first IP address to the network entity, and the network entity may output the NAS request to the core network service associated with the first IP address, for example via a backhaul. The core network may output a NAS message for the UE using the user plane protocol stack, and the NAS message may include or be indicative of the first IP address. For example, the core network may output the NAS message to the network entity via one or more backhaul links, and the network entity may transmit the NAS message to the UE in accordance with the first IP address and the user plane protocol stack. In some examples, the NAS message may include a second IP address associated with a user plane function to the data network. The UE may use the second IP address and the user plane protocol stack to communicate data information with the data network, and the UE may use the first IP address and the same user plane protocol stack to communicate NAS traffic with the core network. In some examples, the network entity may differentiate between the NAS traffic and data traffic in accordance with the first IP address and the second IP address. For example, the UE may use a same channel for the NAS traffic and the data traffic, but the UE may use the different IP addresses to differentiate the types of traffic. Additionally, or alternatively, the network entity may differentiate between the NAS traffic and the data traffic in accordance with channel identifiers of the traffic. For example, the UE may use different channels for the NAS traffic and the data traffic, and traffic may indicate a channel identifier corresponding to either NAS traffic or data traffic.

Particular aspects of the subject matter described in this disclosure may be implemented to realize one or more of the following potential advantages. The techniques employed by the described wireless communication devices may simplify the signaling between the different wireless communication devices by avoiding multiple rounds of coordination for NAS signaling and for PDU session establishment, and by avoiding the NAS signaling serving as a prerequisite for PDU session establishment through using a same protocol stack. Additionally, the techniques employed by the described wireless communication devices may avoid the use of NAS signaling for communication to a UPF by decoupling the NAS signaling and the data signaling, and to enable, for example in the integrated access backhaul (IAB) context, a routing of IP traffic to a backhaul network using a single protocol stack for the routing of the traffic to the backhaul network and a routing of NAS traffic with a core network instead of using separate protocol stacks.

Aspects of the disclosure are initially described in the context of wireless communication systems. Aspects of the disclosure are further illustrated by and described with reference to apparatus diagrams, system diagrams, and flowcharts that relate to PDU session establishment via user plane signaling.

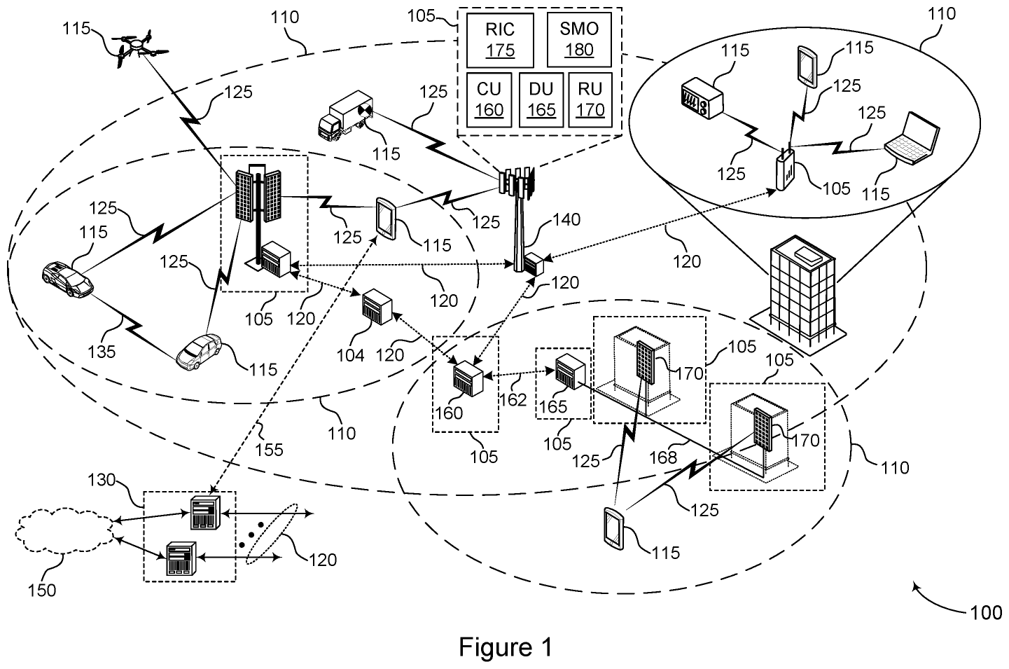

FIG. 1 shows an example of a wireless communication system 100 that supports PDU session establishment via user plane signaling in accordance with one or more aspects of the present disclosure. The wireless communication system 100 may include one or more network entities 105, one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (for example, a radio frequency (RF) access link). For example, a network entity 105 may support a coverage area 110 (for example, a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communication with various types of devices, such as other UEs 115 or network entities 105, as shown in FIG. 1.

A node of the wireless communication system 100, which may be referred to as a network node, or a wireless node, may be a network entity 105 (for example, any network entity described herein), a UE 115 (for example, any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (for example, in accordance with an S1, N2, N3, or other interface protocol). In some examples, network entities 105 may communicate with one another via a backhaul communication link 120 (for example, in accordance with an X2, Xn, or other interface protocol) either directly (for example, directly between network entities 105) or indirectly (for example, via a core network 130). In some examples, network entities 105 may communicate with one another via a midhaul communication link 162 (for example, in accordance with a midhaul interface protocol) or a fronthaul communication link 168 (for example, in accordance with a fronthaul interface protocol), or any combination thereof. The backhaul communication links 120, midhaul communication links 162, or fronthaul communication links 168 may be or include one or more wired links (for example, an electrical link, an optical fiber link), one or more wireless links (for example, a radio link, a wireless optical link), among other examples or various combinations thereof. A UE 115 may communicate with the core network 130 via a communication link 155.

One or more of the network entities 105 described herein may include or may be referred to as a base station 140 (for example, a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (for example, a base station 140) may be implemented in an aggregated (for example, monolithic, standalone) base station architecture, which may be configured to utilize a protocol stack that is physically or logically integrated within a single network entity 105 (for example, a single RAN node, such as a base station 140).

In some examples, a network entity 105 may be implemented in a disaggregated architecture (for example, a disaggregated base station architecture, a disaggregated RAN architecture), which may be configured to utilize a protocol stack that is physically or logically distributed among two or more network entities 105, such as an IAB network, an open RAN (O-RAN) (for example, a network configuration sponsored by the O-RAN Alliance), or a virtualized RAN (vRAN) (for example, a cloud RAN (C-RAN)). For example, a network entity 105 may include one or more of a central unit (CU) 160, a distributed unit (DU) 165, a radio unit (RU) 170, a RAN Intelligent Controller (RIC) 175 (for example, a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (for example, separate physical locations). In some examples, one or more network entities 105 of a disaggregated RAN architecture may be implemented as virtual units (for example, a virtual CU (VCU), a virtual DU (VDU), a virtual RU (VRU)).

The split of functionality between a CU 160, a DU 165, and an RU 170 is flexible and may support different functionalities depending on which functions (for example, network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (for example, layer 3 (L3), layer 2 (L2)) functionality and signaling (for example, Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (for example, physical (PHY) layer) or L2 (for example, radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (for example, via one or more RUs 170). In some cases, a functional split between a CU 160 and a DU 165, or between a DU 165 and an RU 170 may be within a protocol layer (for example, some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (for example, F1, F1-c, F1-u), and a DU 165 may be connected to one or more RUs 170 via a fronthaul communication link 168 (for example, open fronthaul (FH) interface). In some examples, a midhaul communication link 162 or a fronthaul communication link 168 may be implemented in accordance with an interface (for example, a channel) between layers of a protocol stack supported by respective network entities 105 that are in communication via such communication links.

In wireless communication systems (for example, wireless communication system 100), infrastructure and spectral resources for radio access may support wireless backhaul link capabilities to supplement wired backhaul connections, providing an IAB network architecture (for example, to a core network 130). In some cases, in an IAB network, one or more network entities 105 (for example, IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (for example, a donor base station 140). The one or more donor network entities 105 (for example, IAB donors) may be in communication with one or more additional network entities 105 (for example, IAB nodes 104) via supported access and backhaul links (for example, backhaul communication links 120). IAB nodes 104 may include an IAB mobile termination (IAB-MT) controlled (for example, scheduled) by DUs 165 of a coupled IAB donor. An IAB-MT may include an independent set of antennas for relay of communication with UEs 115, or may share the same antennas (for example, of an RU 170) of an IAB node 104 used for access via the DU 165 of the IAB node 104 (for example, referred to as virtual IAB-MT (vIAB-MT)). In some examples, the IAB nodes 104 may include DUs 165 that support communication links with additional entities (for example, IAB nodes 104, UEs 115) within the relay chain or configuration of the access network (for example, downstream). In such cases, one or more components of the disaggregated RAN architecture (for example, one or more IAB nodes 104 or components of IAB nodes 104) may be configured to operate according to the techniques described herein.

For instance, an access network (AN) or RAN may include communication between access nodes (for example, an IAB donor), IAB nodes 104, and one or more UEs 115. The IAB donor may facilitate connection between the core network 130 and the AN (for example, via a wired or wireless connection to the core network 130). That is, an IAB donor may refer to a RAN node with a wired or wireless connection to core network 130. The IAB donor may include a CU 160 and at least one DU 165 (for example, and RU 170), in which case the CU 160 may communicate with the core network 130 via an interface (for example, a backhaul link). IAB donor and IAB nodes 104 may communicate via an F1 interface according to a protocol that defines signaling messages (for example, an F1 AP protocol). Additionally, or alternatively, the CU 160 may communicate with the core network via an interface, which may be an example of a portion of backhaul link, and may communicate with other CUs 160 (for example, a CU 160 associated with an alternative IAB donor) via an Xn-C interface, which may be an example of a portion of a backhaul link.

An IAB node 104 may refer to a RAN node that provides IAB functionality (for example, access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (for example, an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (for example, DUs 165) may provide a Uu interface for a parent IAB node 104 to signal to a child IAB node 104 or UE 115.

For example, IAB node 104 may be referred to as a parent node that supports communication for a child IAB node, or referred to as a child IAB node associated with an IAB donor, or both. The IAB donor may include a CU 160 with a wired or wireless connection (for example, a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (for example, transmissions to the UEs 115 relayed from the IAB donor) through the DUs 165. That is, data may be relayed to and from IAB nodes 104 via signaling via an NR Uu interface to MT of the IAB node 104. Communication with IAB node 104 may be scheduled by a DU 165 of IAB donor and communication with IAB node 104 may be scheduled by DU 165 of IAB node 104.

In the case of the techniques described herein applied in the context of a disaggregated RAN architecture, one or more components of the disaggregated RAN architecture may be configured to support PDU session establishment via user plane signaling. For example, some operations described as being performed by a UE 115 or a network entity 105 (for example, a base station 140) may additionally, or alternatively, be performed by one or more components of the disaggregated RAN architecture (for example, IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communication (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (for example, an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (for example, entity, sub-entity) of a network entity 105. For example, the terms “transmitting,” “receiving,” or “communicating,” when referring to a network entity 105, may refer to any portion of a network entity 105 (for example, a base station 140, a CU 160, a DU 165, a RU 170) of a RAN communicating with another device (for example, directly or via one or more other network entities 105).

In some examples, such as in a carrier aggregation configuration, a carrier may also have acquisition signaling or control signaling that coordinates operations for other carriers. A carrier may be associated with a frequency channel (for example, an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (for example, of the same or a different radio access technology).

The communication links 125 shown in the wireless communication system 100 may include downlink transmissions (for example, forward link transmissions) from a network entity 105 to a UE 115, uplink transmissions (for example, return link transmissions) from a UE 115 to a network entity 105, or both, among other configurations of transmissions. Carriers may carry downlink or uplink communication (for example, in an FDD mode) or may be configured to carry downlink and uplink communication (for example, in a TDD mode).

A carrier may be associated with a particular bandwidth of the RF spectrum and, in some examples, the carrier bandwidth may be referred to as a “system bandwidth” of the carrier or the wireless communication system 100. For example, the carrier bandwidth may be one of a set of bandwidths for carriers of a particular radio access technology (for example, 1.4, 3, 5, 10, 15, 20, 40, or 80 megahertz (MHz)). Devices of the wireless communication system 100 (for example, the network entities 105, the UEs 115, or both) may have hardware configurations that support communication using a particular carrier bandwidth or may be configurable to support communication using one of a set of carrier bandwidths. In some examples, the wireless communication system 100 may include network entities 105 or UEs 115 that support concurrent communication using carriers associated with multiple carrier bandwidths. In some examples, each served UE 115 may be configured for operating using portions (for example, a sub-band, a BWP) or all of a carrier bandwidth.

Signal waveforms transmitted via a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (for example, a duration of one modulation symbol) and one subcarrier, in which case the symbol period and subcarrier spacing may be inversely related. The quantity of bits carried by each resource element may depend on the modulation scheme (for example, the order of the modulation scheme, the coding rate of the modulation scheme, or both), such that a relatively higher quantity of resource elements (for example, in a transmission duration) and a relatively higher order of a modulation scheme may correspond to a relatively higher rate of communication. A wireless communication resource may refer to a combination of an RF spectrum resource, a time resource, and a spatial resource (for example, a spatial layer, a beam), and the use of multiple spatial resources may increase the data rate or data integrity for communication with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communication for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communication resource may be organized according to radio frames each having a specified duration (for example, 10 milliseconds (ms)). Each radio frame may be identified by a system frame number (SFN) (for example, ranging from 0 to 1023).

Each frame may include multiple consecutively-numbered subframes or slots, and each subframe or slot may have the same duration. In some examples, a frame may be divided (for example, in the time domain) into subframes, and each subframe may be further divided into a quantity of slots. Alternatively, each frame may include a variable quantity of slots, and the quantity of slots may depend on subcarrier spacing. Each slot may include a quantity of symbol periods (for example, depending on the length of the cyclic prefix prepended to each symbol period). In some wireless communication systems 100, a slot may further be divided into multiple mini-slots associated with one or more symbols. Excluding the cyclic prefix, each symbol period may be associated with one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communication system 100 and may be referred to as a transmission time interval (TTI). In some examples, the TTI duration (for example, a quantity of symbol periods in a TTI) may be variable. Additionally, or alternatively, the smallest scheduling unit of the wireless communication system 100 may be dynamically selected (for example, in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a set of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (for example, using a carrier) and may be associated with an identifier for distinguishing neighboring cells (for example, a physical cell identifier (PCID), a virtual cell identifier (VCID), or others). In some examples, a cell also may refer to a coverage area 110 or a portion of a coverage area 110 (for example, a sector) over which the logical communication entity operates. Such cells may range from smaller areas (for example, a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (for example, several kilometers in radius) and may allow unrestricted access by the UEs 115 with service subscriptions with the network provider supporting the macro cell. A small cell may be associated with a lower-powered network entity 105 (for example, a lower-powered base station 140), as compared with a macro cell, and a small cell may operate using the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A network entity 105 may support one or multiple cells and may also support communication via the one or more cells using one or multiple component carriers.

In some examples, a carrier may support multiple cells, and different cells may be configured according to different protocol types (for example, MTC, narrowband IoT (NB-IoT), enhanced mobile broadband (eMBB)) that may provide access for different types of devices.

In some examples, a network entity 105 (for example, a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communication system 100 may include, for example, a heterogeneous network in which different types of the network entities 105 provide coverage for various coverage areas 110 using the same or different radio access technologies.

The wireless communication system 100 may support synchronous or asynchronous operation. For synchronous operation, network entities 105 (for example, base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (for example, via Machine-to-Machine (M2M) communication). M2M communication or MTC may refer to data communication technologies that allow devices to communicate with one another or a network entity 105 (for example, a base station 140) without human intervention. In some examples, M2M communication or MTC may include communication from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communication (for example, a mode that supports one-way communication via transmission or reception, but not transmission and reception concurrently). In some examples, half-duplex communication may be performed at a reduced peak rate. Other power conservation techniques for the UEs 115 include entering a power saving deep sleep mode when not engaging in active communication, operating using a limited bandwidth (for example, according to narrowband communication), or a combination of these techniques. For example, some UEs 115 may be configured for operation using a narrowband protocol type that is associated with a defined portion or range (for example, set of subcarriers or resource blocks (RBs)) within a carrier, within a guard-band of a carrier, or outside of a carrier.

The wireless communication system 100 may be configured to support ultra-reliable communication or low-latency communication, or various combinations thereof. For example, the wireless communication system 100 may be configured to support ultra-reliable low-latency communication (URLLC). The UEs 115 may be designed to support ultra-reliable, low-latency, or critical functions. Ultra-reliable communication may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (for example, in accordance with a peer-to-peer (P2P), D2D, or sidelink protocol). In some examples, one or more UEs 115 of a group that are performing D2D communication may be within the coverage area 110 of a network entity 105 (for example, a base station 140, an RU 170), which may support aspects of such D2D communication being configured by (for example, scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communication may support a one-to-many (1:M) system in which each UE 115 transmits to each of the other UEs 115 in the group. In some examples, a network entity 105 may facilitate the scheduling of resources for D2D communication. In some other examples, D2D communication may be carried out between the UEs 115 without an involvement of a network entity 105.

In some systems, a D2D communication link 135 may be an example of a communication channel, such as a sidelink communication channel, between vehicles (for example, UEs 115). In some examples, vehicles may communicate using vehicle-to-everything (V2X) communication, vehicle-to-vehicle (V2V) communication, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (for example, network entities 105, base stations 140, RUs 170) using vehicle-to-network (V2N) communication, or with both.

The core network 130 may provide user authentication, access authorization, tracking, IP connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a UPF). The control plane entity may manage NAS functions such as mobility, authentication, and bearer management for the UEs 115 served by the network entities 105 (for example, base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communication using UHF waves may be associated with smaller antennas and shorter ranges (for example, less than 100 kilometers) compared to communication using the smaller frequencies and longer waves of the high frequency (HF) or very high frequency (VHF) portion of the spectrum below 300 MHz.

The wireless communication system 100 may also operate using a super high frequency (SHF) region, which may be in the range of 3 GHz to 30 GHz, also known as the centimeter band, or using an extremely high frequency (EHF) region of the spectrum (for example, from 30 GHz to 300 GHz), also known as the millimeter band. In some examples, the wireless communication system 100 may support millimeter wave (mmW) communication between the UEs 115 and the network entities 105 (for example, base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed RF spectrum bands. For example, the wireless communication system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (for example, LAA). Operations using unlicensed spectrum may include downlink transmissions, uplink transmissions, P2P transmissions, or D2D transmissions, among other examples.

A network entity 105 (for example, a base station 140, an RU 170) or a UE 115 may be equipped with multiple antennas, which may be used to employ techniques such as transmit diversity, receive diversity, multiple-input multiple-output (MIMO) communication, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communication with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communication to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (for example, the same codeword) or different data streams (for example, different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (for example, a network entity 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A network entity 105 or a UE 115 may use beam sweeping techniques as part of beamforming operations. For example, a network entity 105 (for example, a base station 140, an RU 170) may use multiple antennas or antenna arrays (for example, antenna panels) to conduct beamforming operations for directional communication with a UE 115. Some signals (for example, synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (for example, by a transmitting device, such as a network entity 105, or by a receiving device, such as a UE 115) a beam direction for later transmission or reception by the network entity 105.

Some signals, such as data signals associated with a particular receiving device, may be transmitted by transmitting device (for example, a transmitting network entity 105, a transmitting UE 115) along a single beam direction (for example, a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (for example, by a network entity 105 or a UE 115) may be performed using multiple beam directions, and the device may use a combination of digital precoding or beamforming to generate a combined beam for transmission (for example, from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted along one or more directions by a network entity 105 (for example, a base station 140, an RU 170), a UE 115 may employ similar techniques for transmitting signals multiple times along different directions (for example, for identifying a beam direction for subsequent transmission or reception by the UE 115) or for transmitting a signal along a single direction (for example, for transmitting data to a receiving device).

A receiving device (for example, a UE 115) may perform reception operations in accordance with multiple receive configurations (for example, directional listening) when receiving various signals from a transmitting device (for example, a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, when receiving a data signal). The single receive configuration may be aligned along a beam direction determined based on listening according to different receive configuration directions (for example, a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communication at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (for example, a communication link 125, a D2D communication link 135). HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communication systems, a UE 115 may use separate protocol stacks for the exchange of data traffic with a data network and for the exchange of NAS signaling with a core network. For example, the UE 115 may use a use plane protocol stack to communicate data with the data network and a control plane protocol stack to communicate control signaling or NAS signaling with the core network. A UE 115 in the wireless communication system 100 may use a user plane protocol stack for both data traffic with the data network and for NAS signaling to the core network. Some techniques of other systems may not support using a single protocol stack for both data traffic and NAS traffic.

For example, in some systems, connectivity to a data network may be based on a PDU session between a UE 115 and a UPF. The PDU session may be established via NAS signaling. The UE 115 in these systems may use NAS signaling to establish the PDU session. The UPF may support multiple functions, such packet inspection, packet routing and forwarding, and QoS handling. However, none of these functions except for packet forwarding may be supported for NAS signaling in these systems. A wireless communication system may be able to not use a UPF for NAS signaling, but without the UPF, the UE 115 may not establish a PDU session using current techniques. Techniques to communicate NAS signaling and data traffic using a same protocol stack may not be supported using current techniques.

Some wireless communication systems supporting IAB may use an IP routing function. The IP routing function may enable an IAB node to route IP traffic to the backhaul network using an IP address obtained from the IAB donor DU's IP subnet on the backhaul network. However, the IP routing function may use a different protocol stack for routing traffic to the backhaul network than routing NAS traffic.

The wireless communication system 100 may support techniques to for a UE 115 to use one common user plane protocol stack for both NAS traffic to a core network and data plane traffic to a data network. A network entity 105 may support an IP router function to the backhaul IP network. The UE 115 may receive, from the network entity 105 via a wireless channel, a first IP address. The first IP address may be associated with a subnet of network entities 105 and core network services on a backhaul IP network, including the network entity 105.

The UE 115 may use the first IP address and the user plane protocol stack to send a NAS request to a core network service to establish a PDU session to a data network. For example, the NAS request may have a header with a field that indicates the first IP address. The core network service may return a NAS reply message using the first IP address and the user plane protocol stack. For example, the NAS reply message may have a header with a field that indicates the first IP address. The NAS reply message may include a second IP address which is associated with or anchored to a user plane function to the data network.

The network entity 105 may route traffic to the backhaul network or a session tunnel to the UPF based on whether the traffic is NAS traffic or data traffic. In some examples, the network entity 105 may differentiate between NAS traffic and data traffic of the PDU session based on whether the traffic includes, or indicates, the first IP address or the second IP address. For example, if a PDU includes or is indicative of the first IP address, the network entity 105 may forward the PDU to the core network. If the PDU includes or is indicative of the second IP address, the network entity 105 may forward the PDU to a session tunnel associated with the data network.

In some examples, the network entity 105 may differentiate traffic based on channel identifiers. For example, NAS traffic and data traffic may be communicated using different channels. The UE 115 may transmit NAS traffic via a first channel (for example, a first Layer 2 channel), and the UE 115 may transmit data traffic via a second channel (for example, a second Layer 2 channel). If traffic includes a first channel identifier associated with the first channel, the network entity 105 may forward the packets to the backhaul network. If the traffic includes a second channel identifier associated with the second channel, the network entity 105 may forward the packets to a tunnel to the UPF.

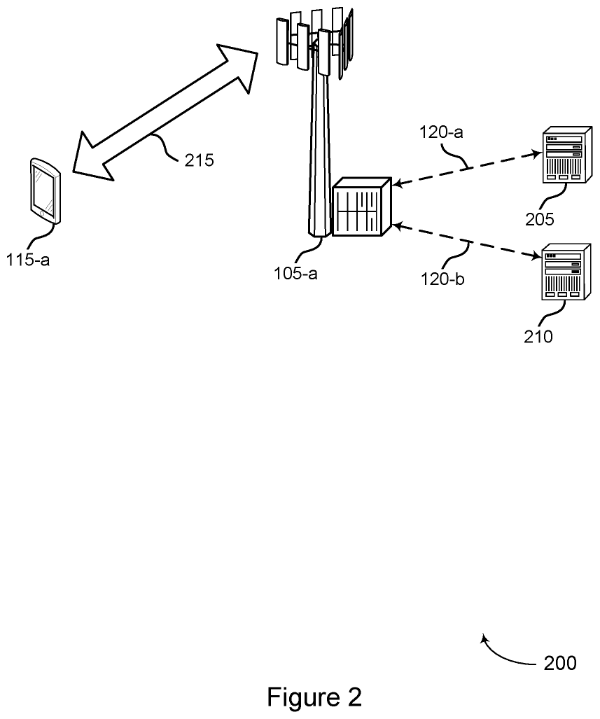

FIG. 2 shows an example of a wireless communication system 200 that supports PDU session establishment via user plane signaling in accordance with one or more aspects of the present disclosure. The wireless communication system 200 may include a UE 115-a, a network entity 105-a, a core network entity 205, and a data network entity 210. The UE 115-a and the network entity 105-a may be respective examples of a UE 115 and a network entity 105 as described with reference to FIG. 1. The core network entity 205 may be an example of aspects of a core network 130 as described with reference to FIG. 1. The data network entity 210 may be associated with or an example of a UPF.

The UE 115-a may use one common protocol stack for NAS traffic to a core network and for data plane traffic to a data network. For example, the UE 115-a may use the same protocol stack to send NAS traffic to the core network entity 205 and data traffic to the data network entity 210. The network entity 105-a may support an IP router function to a backhaul IP network. For example, the network entity 105-a may be able to route or forward packets or PDUs to different entities or services, such as the core network entity 205 or the data network entity 210. In some examples, the network entity 105-a may send packets to the core network entity 205 via a backhaul communication link 120-a, and the network entity 105-a may send packets to the data network entity 210 via a backhaul communication link 120-b.

The network entity 105-a may transmit information indicative of a first IP address to the UE 115-a over the wireless channel 215. The first IP address may be associated with a subnet of network entities and core network services on a backhaul IP network, including the network entity 105-a. In some examples, the backhaul IP network may include the core network entity 205 or the data network entity 210, or both.

The UE 115-a may use the first IP address and the user plane protocol stack to transmit a NAS request to a core network service to establish a PDU session with a data network. For example, the UE 115-a may transmit the NAS request indicating the first IP address to the network entity 105-a. In some examples, the NAS request may include a network entity identifier or base station identifier, such as an identifier for a network entity 105 or base station serving the UE 115-a. For example, the NAS request may include an identifier of the network entity 105-a. The network entity identifier or base station identifier included in the NAS request may be, for example, a cell global identity, an IP address, or a fully qualified domain name (FQDN). In some examples, the network entity 105-a may transmit an identifier for the network entity 105-a to the UE 115-a before the UE 115-a transmits the NAS request, such as during a connection establishing procedure.

The network entity 105-a may output or forward the NAS request to the core network service associated with the first IP address, for example via the backhaul communication link 120-a. For example, the network entity 105-a may forward the NAS request to the core network entity 205 via the backhaul communication link 120-a. In accordance with NAS request, or NAS PDU session request, the core network service may send a session tunnel information for the UE 115-a to the network entity 105-a. In some examples, the session tunnel information may include a PDU session identifier. In some examples, the session tunnel information may include a core network service identifier associated with a core network service. In some examples, the session tunnel information may include an identifier of the UE 115-a. The network entity 105-a may identify the UE 115 associated with the session tunnel information based on the identifier.

The core network may output a NAS reply message or a NAS response message for the UE 115-a using the first IP address and the user plane protocol stack. In some examples, the NAS response message may indicate the first IP address, or the NAS response message may include, or be transmitted with, a header which indicates the first IP address. For example, the core network entity 205 may output the NAS response message to the network entity 105-a via the backhaul communication link 120-a, and the network entity 105-a may transmit the response message to the UE 115-ausing the user plane protocol stack in accordance with the first IP address. In some examples, the core network entity 205 may send the session tunnel information based on the identifier included in the NAS request. The response message may include a second IP address associated with the UPF to the data network.

The UE 115-a may use the second IP address and the user plane protocol stack to communicate data information with the data network, and the UE 115-a may use the first IP address and the same user plane protocol stack to communicate NAS traffic with the core network. For example, data information may include the second IP address, and NAS traffic may include the first IP address. For example, the UE 115-a may use the first IP address and the user plane protocol stack to communicate NAS traffic with the core network entity 205, and the UE 115-a may use the second IP address and the same user plane protocol stack to communicate data traffic with the data network entity 210.

In some examples, the UE 115-a may use the same channel for NAS traffic and data traffic. For example, the UE 115-a may communicate both NAS signaling and data traffic signaling via a same wireless channel (for example, a wireless channel 215). The network entity 105-a may differentiate between NAS traffic and data traffic according to an IP address of the traffic. For example, the network entity 105-a may forward packets carrying the first IP address to the core network, and the network entity 105-a may forward packets carrying the second IP address to the session tunnel. In some examples, the session tunnel information received from the core network service may include the second IP address, and the network entity 105-a may forward or send uplink data traffic carrying the second IP address to the session tunnel.

In some examples, the UE 115-a may use different channels for NAS traffic and data traffic. For example, the network entity 105-a may configure the UE 115-a with a first wireless channel having a first channel identifier. The UE 115-a may use the first wireless channel to transmit or receive NAS signaling. In some examples, the network entity 105-a may indicate or configure the first wireless channel and the first IP address together. When the network entity 105-a receives the session tunnel information from the core network, the network entity 105-a may configure the UE 115-a with a second wireless channel having a second channel identifier. The network entity 105-a may indicate the second IP address, the PDU session identifier, and the core network service identifier together. In some examples, indicating the second IP address, the PDU session identifier, and the core network service identifier together may indicate a mapping between the PDU session identifier, the second IP address, and the second L2 channel to the UE 115-a. In some examples, the UE 115-a may receive the PDU session identifier from a PDU session information configured by the core network service. The UE 115-a may map the PDU session to the second IP address and the second logical channel identifier based on receiving the PDU session identifier from the PDU session information

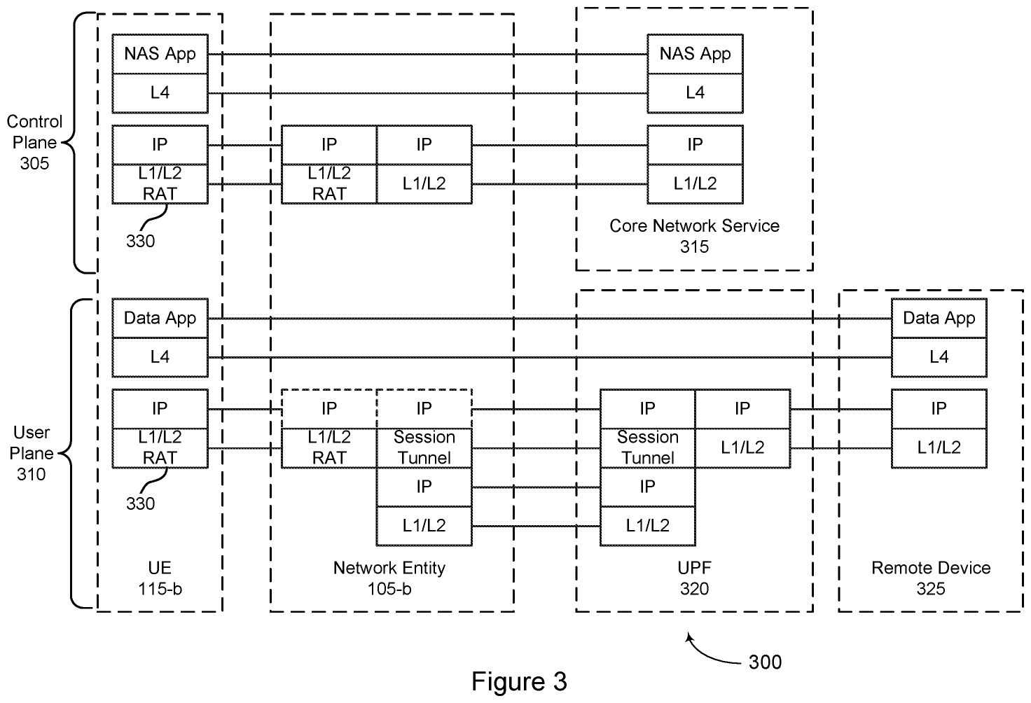

FIG. 3 shows an example of protocol stacks 300 that supports PDU session establishment via user plane signaling in accordance with one or more aspects of the present disclosure.

The protocol stacks 300 may be implemented by devices and entities in a wireless communication system to communicate signaling via a control plane 305 and a user plane 310. For example, the protocol stacks 300 may be used by a UE 115-b, a network entity 105-b, a core network service 315, a UPF 320, or a remote device 325, or any combination thereof. The UE 115-b and the network entity 105-b may be respective examples of a UE 115 and a network entity 105 as described with reference to FIGS. 1 and 2. The core network service 315 may be an example of a core network service or a core network entity 205 as described with reference to FIG. 2. The UPF 320 may be an example of a data network entity 210 as described with reference to FIG. 2.

The UE 115-b may use one common user plane protocol stack of a RAT for NAS traffic to the core network and for data plane traffic to the data network. For example, the UE 115-b may use a user plane protocol stack 330 to transmit NAS signaling to the core network service 315, and the UE 115-b may use the user plane protocol stack 330 to transmit data signaling to the remote device 325. The user plane protocol stack 330 may include one or more layers or sub-layers for L1 and L2 signaling, such as an SDAP sub-layer, a PDCP sub-layer, an RLC sub-layer, a MAC sub-layer, and a physical sub-layer.

The network entity 105-b may differentiate between NAS traffic and data traffic based on either an IP address of the traffic or a channel identifier of a wireless channel carrying the traffic. For example, the NAS traffic and the data traffic may use a same channel, and the network entity 105-b may differentiate the traffic based on IP addresses. For example, if the network entity 105-b receives a PDU from the UE 115-b that includes a first IP address that corresponds to NAS traffic, the network entity 105-b may forward the PDU to the core network service 315. If the network entity 105-b receives a PDU from the UE 115-b that includes a second IP address that corresponds to data traffic, the network entity 105-b may forward the PDU to a session tunnel corresponding to the UPF 320.

In some examples, the NAS traffic and the data traffic may use different channels, and the network entity 105-b may differentiate between the traffic based on channel identifiers. For example, if the network entity 105-b receives a PDU from the UE 115-b via a first wireless channel or indicating a first channel identifier that corresponds to NAS traffic, the network entity 105-b may forward the PDU to the core network service 315. If the network entity 105-b receives a PDU from the UE 115-b via a second wireless channel or indicating a second channel identifier that corresponds to data traffic, the network entity 105-b may forward the PDU to a session tunnel corresponding to the UPF 320.

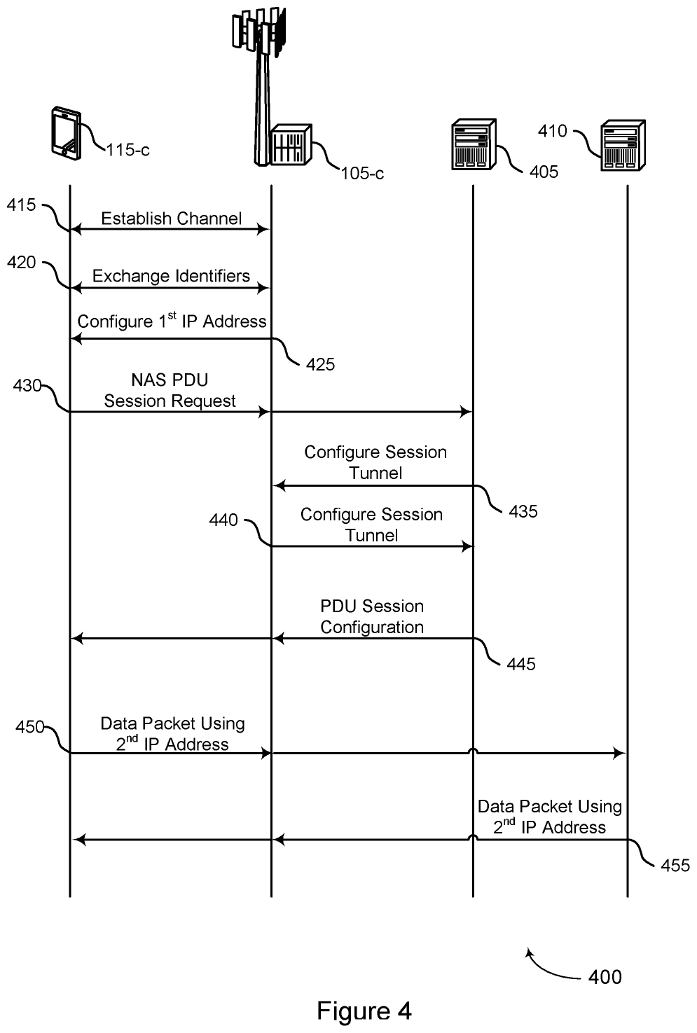

FIG. 4 shows an example of a process flow 400 that supports PDU session establishment via user plane signaling in accordance with one or more aspects of the present disclosure. In some examples, aspects of the process flow 400 may implement or be implemented by aspects of the wireless communication system 100 or the wireless communication system 200. For example, the process flow 400 may be implemented by a UE 115-c, a network entity 105-c, a core network service 405, and a UPF 410, which may be examples of the corresponding devices as described with reference to FIGS. 1-3. The process flow 400 may be implemented to communicate NAS traffic and data traffic using a single user plane protocol stack, where the network entity 105-c may differentiate between the NAS traffic and data traffic based on IP addresses.

In some examples, the network entity 105-c may be an example of a DU, a CU, a base station, or an access point. In some examples, the UPF 410 may be an example of or correspond to aspects of a data service, such as a network function, a network node, or a session management function.

In the following description of the process flow 400, the operations between the network entity 105-c, the UE 115-c, the core network service 405, and the UPF 410 may be performed in a different order than the example order shown. Some operations may also be omitted from the process flow 400, and other operations may be added to the process flow 400. Further, although some operations or signaling may be shown to occur at different times for discussion purposes, these operations may actually occur at the same time.

At 415, the UE 115-c and the network entity 105-c may establish a signaling channel or a wireless link. For example, the UE 115-c and the network entity 105-cmay perform a connection establishing procedure, such as a random access procedure. In some examples, at 420, the UE 115-c and the network entity 105-c may exchange identifiers. For example, the UE 115-c may indicate a UE identifier of the UE 115-c to the network entity 105-c, and the network entity 105-c may indicate a network entity identifier or base station identifier for the network entity 105-c to the UE 115-c. In some examples, the identifier of the network entity 105-c may be a cell-global identifier, an IP address, a transport layer network identifier, or an FQDN.

At 425, the network entity 105-c may transmit an indication of a first IP address to the UE 115-c. For example, the UE 115-c may receive first information indicative of a first IP address. In some examples, the network entity 105-c may transmit a configuration of the first IP address for use of NAS traffic. In some examples, the UE 115-c may receive, over a channel of the wireless link, a first channel identifier, a second channel identifier, and the first IP address, or any combination thereof. In some examples, the first IP address may correspond to a subnet of network devices, which may include the network entity 105-c and the core network service 405.

At 430, the UE 115-c may transmit a NAS request to the core network service 405 that indicates or uses the first IP address. For example, the UE 115-c may transmit a NAS request to the core network service 405 to establish a PDU session using the first IP address and a user plane protocol stack. The NAS PDU session request may include the identifier of the UE 115-c and the identifier of the network entity 105-c. The network entity 105-c may route the user plane data packet to a backhaul network based on the first IP address contained in the user plane data packet.

At 435 and 440, the network entity 105-c and the core network service 405 may configure a PDU session tunnel. For example, at 435, the core network service 405 may transmit session tunnel information to the network entity 105-c, such as to configure a session tunnel end point at the UPF 410. The network entity 105-c may receive, via a backhaul link, a message with session tunnel information and a data session identifier. In some examples, the data session identifier may include a core network service identifier. In some examples, the session tunnel information may include the identifier of the UE 115-c, a second IP address, a PDU session identifier, a core network service identifier associated with the core network service 405, or any combination thereof. At 440, the network entity 105-c may transmit information to configure a corresponding session tunnel endpoint for the PDU session at the network entity 105-c.

At 445, the core network service 405 may transmit information to configure a NAS PDU session to the UE 115-c. For example, the UE 115-c may receive, from the core network service 405 using the first IP address and the user plane protocol stack, a NAS response including second information indicative of a second IP address. In some examples, the NAS response may indicate the second IP address, the PDU session identifier, and the core network service identifier, or any combination thereof. In some examples, the network entity 105-c may route packets corresponding to the NAS response to the UE 115-c according to the packet including the first IP address.

At 450, the UE 115-c may transmit data information to a data network via the UPF 410 that indicates or uses the second IP address. For example, the UE 115-c may transmit data information associated with the PDU session using the second IP address and the user plane protocol stack. The network entity 105-c may forward user plane data packets to the UPF via the session tunnel based on the user plane data packets including the second IP address. At 455, the UE 115-c may receive a data packet from the data network via the UPF 410 in accordance with the second IP address. For example, the network entity 105-c may forward user plane data packets to the UE 115-c according to the user plane data packets indicating the session tunnel identifier or the second IP address, or both.

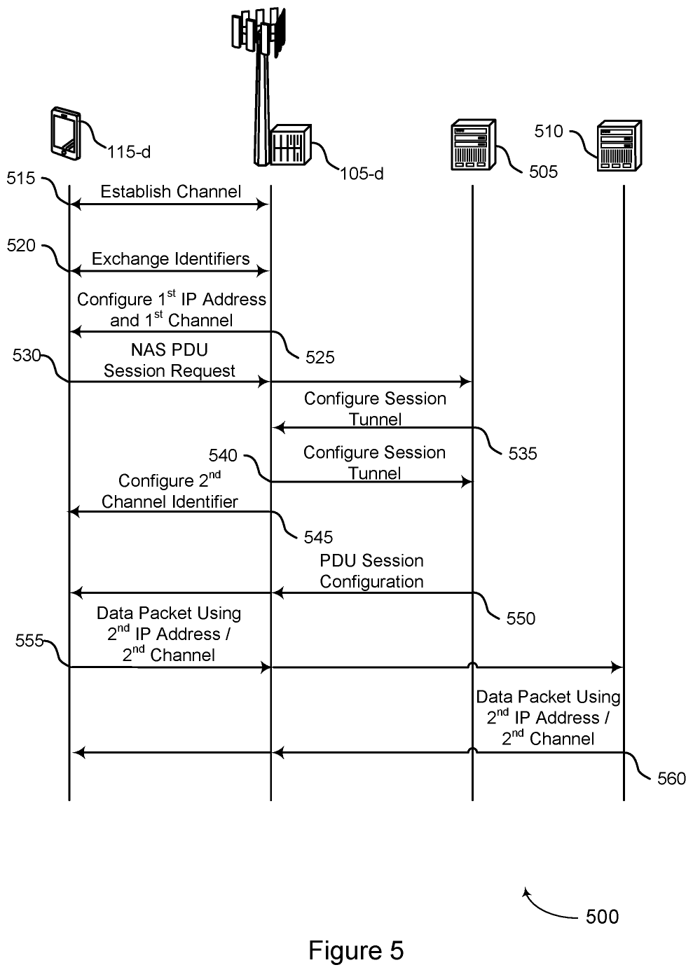

FIG. 5 shows an example of a process flow 500 that supports PDU session establishment via user plane signaling in accordance with one or more aspects of the present disclosure. In some examples, aspects of the process flow 500 may implement or be implemented by aspects of the wireless communication system 100 or the wireless communication system 200. For example, the process flow 500 may be implemented by a UE 115-d, a network entity 105-d, a core network service 505, and a UPF 510, which may be examples of the corresponding devices as described with reference to FIGS. 1-3. The process flow 500 may be implemented to communicate NAS traffic and data traffic using a single user plane protocol stack, where the network entity 105-d may differentiate between the NAS traffic and data traffic based on wireless channels or channel identifiers.

In some examples, the network entity 105-d may be an example of a DU, a CU, a base station, or an access point. In some examples, the UPF 510 may be an example of or correspond to aspects of a data service, such as a network function, a network node, or a session management function.

In the following description of the process flow 500, the operations between the network entity 105-d, the UE 115-d, the core network service 505, and the UPF 510 may be performed in a different order than the example order shown. Some operations may also be omitted from the process flow 500, and other operations may be added to the process flow 500. Further, although some operations or signaling may be shown to occur at different times for discussion purposes, these operations may actually occur at the same time.

At 515, the UE 115-d and the network entity 105-d may establish a signaling channel or a wireless link. For example, the UE 115-d and the network entity 105-d may perform a connection establishing procedure, such as a random access procedure. In some examples, at 520, the UE 115-d and the network entity 105-d may exchange identifiers. For example, the UE 115-d may indicate a UE identifier of the UE 115-d to the network entity 105-d, and the network entity 105-d may indicate a network entity identifier or base station identifier for the network entity 105-d to the UE 115-d. In some examples, the identifier of the network entity 105-d may be a cell-global identifier, an IP address, a transport layer network identifier, or an FQDN.

At 525, the network entity 105-d may configure the UE 115-d with a first IP address and a first wireless channel for NAS traffic. For example, the UE 115-d may receive first information indicative of a first IP address and the first wireless channel. In some examples, the UE 115-d may receive, over a channel of the wireless link, a first channel identifier, a second channel identifier, and the first IP address, or any combination thereof. In some examples, the first IP address may correspond to a subnet of network devices, which may include the network entity 105-d and the core network service 505. The first channel may be an example of an L2 channel. For example, the first channel identifier may be an example of a logical channel identifier, an RLC channel identifier, an RLC entity identifier, a PDCP entity identifier, or an L2 entity identifier.

At 530, the UE 115-d may transmit a NAS request to the core network service 505 using the first IP address and the first channel. For example, the UE 115-d may transmit a NAS request to the core network service 505 to establish a PDU session using the first IP address, a user plane protocol stack, and the first channel. In some examples, the NAS PDU session request may include the identifier of the UE 115-d and the identifier of the network entity 105-d. The network entity 105-d may route a user plane data packet to a backhaul network based on the channel used to transmit the user plane data packet or a channel identifier of the channel used to transmit the user plane data packet.

At 535 and 540, the network entity 105-d and the core network service 505 may configure a PDU session tunnel. For example, at 535, the core network service 505 may transmit session tunnel information to the network entity 105-d, such as to configure a session tunnel end point at the UPF 510. The network entity 105-d may receive, via a backhaul link, a message with session tunnel information and a data session identifier. In some examples, the data session identifier may include a core network service identifier. In some examples, the session tunnel information may include the identifier of the UE 115-d, a second IP address, a PDU session identifier, a core network service identifier associated with the core network service 505, or any combination thereof. At 540, the network entity 105-d may transmit information to configure a corresponding session tunnel endpoint for the PDU session at the network entity 105-d.

In some examples, at 545, the network entity 105-d may transmit information to the UE 115-d that is indicative of a second channel or second channel identifier for the PDU session. For example, the network entity 105-d may indicate a PDU session identifier, a core network service identifier, and a second IP address associated with the PDU session, or any combination thereof.

At 550, the core network service 505 may transmit information to configure a NAS PDU session to the UE 115-d. For example, the UE 115-d may receive, from the core network service 505 using the user plane protocol stack, a NAS response that indicates the first IP address, the NAS response including second information indicative of a second IP address or a second channel identifier, or both. In some examples, the NAS response may indicate the second IP address, the second channel identifier, the PDU session identifier, and the core network service identifier, or any combination thereof. In some examples, the network entity 105-d may route the NAS response to the UE 115-d according to the NAS response including the first IP address. In some examples, the core network service 505 may indicate the second channel identifier with the PDU session identifier.

At 555, the UE 115-d may transmit data information to a data network via the UPF 510 using the second IP address and the second channel. For example, the UE 115-d may transmit data information associated with the PDU session using the second IP address, the user plane protocol stack, and the second channel having the second channel identifier. The network entity 105-d may forward user plane data packets to the UPF via the session tunnel based on the user plane data packets including the second channel identifier. At 560, the UE 115-d may receive a data packet from the data network via the UPF 510 in accordance with the second IP address and the second channel identifier. For example, the network entity 105-d may forward user plane data packets to the UE 115-d based on the user plane data packets indicating the session tunnel identifier, the second IP address, the second channel identifier, or any combination thereof.

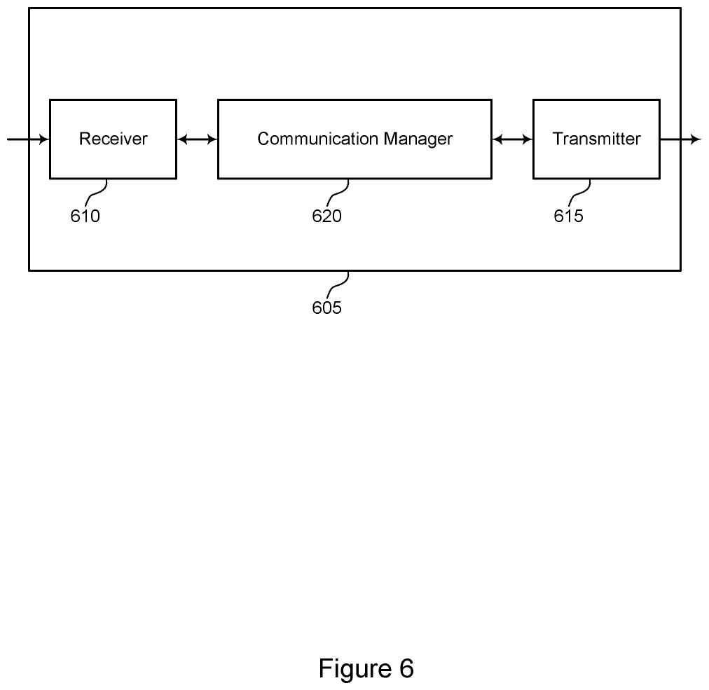

FIG. 6 shows a block diagram of a device 605 that supports PDU session establishment via user plane signaling in accordance with one or more aspects of the present disclosure. The device 605 may be an example of aspects of a UE 115. The device 605 may include a receiver 610, a transmitter 615, and a communication manager 620. The device 605, or one or more components of the device 605 (for example, the receiver 610, the transmitter 615, and the communication manager 620), may include at least one processor, which may be coupled with at least one memory, to, individually or collectively, support or enable the described techniques. Each of these components may be in communication with one another (for example, via one or more buses).

The receiver 610 may provide a means for receiving information such as packets, user data, control information, or any combination thereof associated with various information channels (for example, control channels, data channels, information channels related to PDU session establishment via user plane signaling). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (for example, control channels, data channels, information channels related to PDU session establishment via user plane signaling). In some examples, the transmitter 615 may be co-located with a receiver 610 in a transceiver component. The transmitter 615 may utilize a single antenna or a set of multiple antennas.

The communication manager 620, the receiver 610, the transmitter 615, or various combinations thereof or various components thereof may be examples of means for performing various aspects of PDU session establishment via user plane signaling. For example, the communication manager 620, the receiver 610, the transmitter 615, or various combinations or components thereof may be capable of performing one or more of the functions described herein.

In some examples, the communication manager 620, the receiver 610, the transmitter 615, or various combinations or components thereof may be implemented in hardware (for example, in communication management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

Additionally, or alternatively, the communication manager 620, the receiver 610, the transmitter 615, or various combinations or components thereof may be implemented in code (for example, as communication management software or firmware) executed by at least one processor. If implemented in code executed by at least one processor, the functions of the communication manager 620, the receiver 610, the transmitter 615, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communication manager 620 may be configured to perform various operations (for example, receiving, obtaining, monitoring, outputting, transmitting) using or otherwise in cooperation with the receiver 610, the transmitter 615, or both. For example, the communication manager 620 may receive information from the receiver 610, send information to the transmitter 615, or be integrated in combination with the receiver 610, the transmitter 615, or both to obtain information, output information, or perform various other operations.

The communication manager 620 may support wireless communication in accordance with examples as disclosed herein. For example, the communication manager 620 is capable of, configured to, or operable to support a means for receiving first information indicative of a first IP address. The communication manager 620 is capable of, configured to, or operable to support a means for transmitting a NAS request that indicates the first IP address to a core network service to establish a PDU session using user plane protocol stack. The communication manager 620 is capable of, configured to, or operable to support a means for receiving, from the core network service using the user plane protocol stack, a NAS response that indicates the first IP address, the NAS response including second information indicative of a second IP address. The communication manager 620 is capable of, configured to, or operable to support a means for transmitting NAS information that indicates the first IP address to the core network service using the user plane protocol stack, and first data information associated with the PDU session that indicates the second IP address using the user plane protocol stack.

By including or configuring the communication manager 620 in accordance with examples as described herein, the device 605 (for example, at least one processor controlling or otherwise coupled with the receiver 610, the transmitter 615, the communication manager 620, or a combination thereof) may support techniques for reduced processing and reduced power consumption.

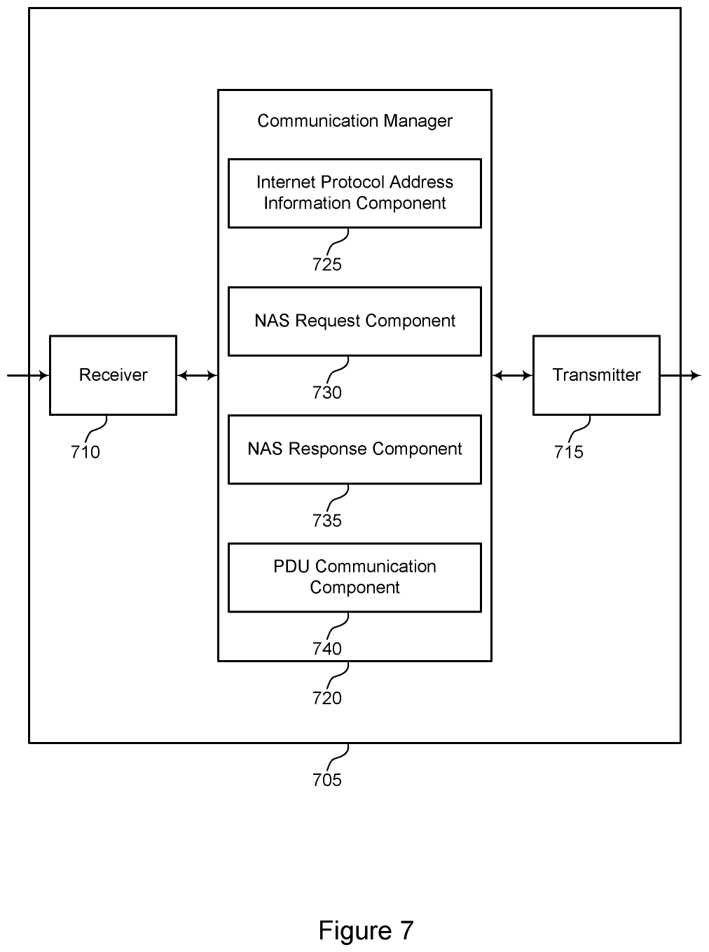

FIG. 7 shows a block diagram of a device 705 that supports PDU session establishment via user plane signaling in accordance with one or more aspects of the present disclosure. The device 705 may be an example of aspects of a device 605 or a UE 115 as described herein. The device 705 may include a receiver 710, a transmitter 715, and a communication manager 720. The device 705, or one of more components of the device 705 (for example, the receiver 710, the transmitter 715, and the communication manager 720), may include at least one processor, which may be coupled with at least one memory, to support the described techniques. Each of these components may be in communication with one another (for example, via one or more buses).

The receiver 710 may provide a means for receiving information such as packets, user data, control information, or any combination thereof associated with various information channels (for example, control channels, data channels, information channels related to PDU session establishment via user plane signaling). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (for example, control channels, data channels, information channels related to PDU session establishment via user plane signaling). In some examples, the transmitter 715 may be co-located with a receiver 710 in a transceiver component. The transmitter 715 may utilize a single antenna or a set of multiple antennas.

The device 705, or various components thereof, may be an example of means for performing various aspects of PDU session establishment via user plane signaling as described herein. For example, the communication manager 720 may include an IP address information component 725, a NAS request component 730, a NAS response component 735, a PDU communication component 740, or any combination thereof. In some examples, the communication manager 720, or various components thereof, may be configured to perform various operations (for example, receiving, obtaining, monitoring, outputting, transmitting) using or otherwise in cooperation with the receiver 710, the transmitter 715, or both. For example, the communication manager 720 may receive information from the receiver 710, send information to the transmitter 715, or be integrated in combination with the receiver 710, the transmitter 715, or both to obtain information, output information, or perform various other operations as described herein.

The communication manager 720 may support wireless communication in accordance with examples as disclosed herein. The IP address information component 725 is capable of, configured to, or operable to support a means for receiving first information indicative of a first IP address. The NAS request component 730 is capable of, configured to, or operable to support a means for transmitting a NAS request that indicates the first IP address to a core network service to establish a PDU session using a user plane protocol stack. The NAS response component 735 is capable of, configured to, or operable to support a means for receiving, from the core network service using the user plane protocol stack, a NAS response that indicates the first IP address, the NAS response including second information indicative of a second IP address. The PDU communication component 740 is capable of, configured to, or operable to support a means for transmitting NAS information that indicates the first IP address to the core network service using the user plane protocol stack, and first data information associated with the PDU session that indicates the second IP address using the user plane protocol stack.

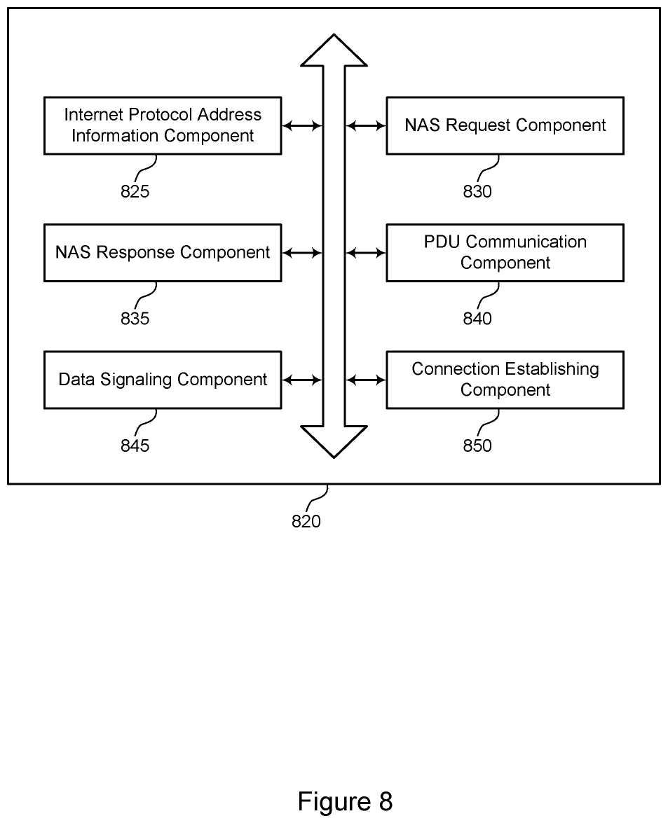

FIG. 8 shows a block diagram of a communication manager 820 that supports PDU session establishment via user plane signaling in accordance with one or more aspects of the present disclosure. The communication manager 820, or various components thereof, may be an example of means for performing various aspects of PDU session establishment via user plane signaling as described herein. For example, the communication manager 820 may include an IP address information component 825, a NAS request component 830, a NAS response component 835, a PDU communication component 840, a data signaling component 845, a connection establishing component 850, or any combination thereof. Each of these components, or components or subcomponents thereof (for example, one or more processors, one or more memories), may communicate, directly or indirectly, with one another (for example, via one or more buses).

The communication manager 820 may support wireless communication in accordance with examples as disclosed herein. The IP address information component 825 is capable of, configured to, or operable to support a means for receiving first information indicative of a first IP address. The NAS request component 830 is capable of, configured to, or operable to support a means for transmitting a NAS request that indicates the first IP address to a core network service to establish a PDU session using a user plane protocol stack. The NAS response component 835 is capable of, configured to, or operable to support a means for receiving, from the core network service using the user plane protocol stack, a NAS response that indicates the first IP address, the NAS response including second information indicative of a second IP address. The PDU communication component 840 is capable of, configured to, or operable to support a means for transmitting NAS information that indicates the first IP address to the core network service using the user plane protocol stack, and first data information associated with the PDU session that indicates the second IP address using the user plane protocol stack.

In some examples, the data signaling component 845 is capable of, configured to, or operable to support a means for receiving second data information associated with the PDU session that indicates the second IP address using the user plane protocol stack.

In some examples, the first data information and the NAS information are transmitted using a same wireless channel.

In some examples, a first wireless channel carrying the NAS request associated with NAS signaling is associated with a first channel identifier.

In some examples, the first information indicates the first channel identifier with the first IP address.

In some examples, the first channel identifier is a logical channel identifier, a radio link control channel identifier, an adaptation layer identifier, a radio link control entity identifier, a packet data convergence protocol entity identifier, or a layer two entity identifier, or any combination thereof.

In some examples, the IP address information component 825 is capable of, configured to, or operable to support a means for receiving, in response to the NAS request, third information that indicates a second channel identifier associated with the PDU session.

In some examples, a second wireless channel carrying the first data information is associated with the second channel identifier.

In some examples, the data signaling component 845 is capable of, configured to, or operable to support a means for receiving, using the user plane protocol stack, second data information associated with the PDU session, where a second wireless channel carrying the second data information is associated with the second channel identifier.

In some examples, the first information is indicative of a first channel identifier associated with NAS signaling and a second channel identifier associated with a PDU transfer.

In some examples, the NAS request includes fourth information indicative of a first identifier of a network entity associated with the PDU session, a second identifier of the UE, or both.

In some examples, the NAS response includes fifth information indicative of a PDU session identifier associated with the PDU session.

In some examples, the connection establishing component 850 is capable of, configured to, or operable to support a means for transmitting, via a connection establishing procedure, an indication of a UE identifier of the UE. In some examples, the connection establishing component 850 is capable of, configured to, or operable to support a means for receiving, via the connection establishing procedure, an indication of a network entity identifier of a network entity associated with the user plane protocol stack.

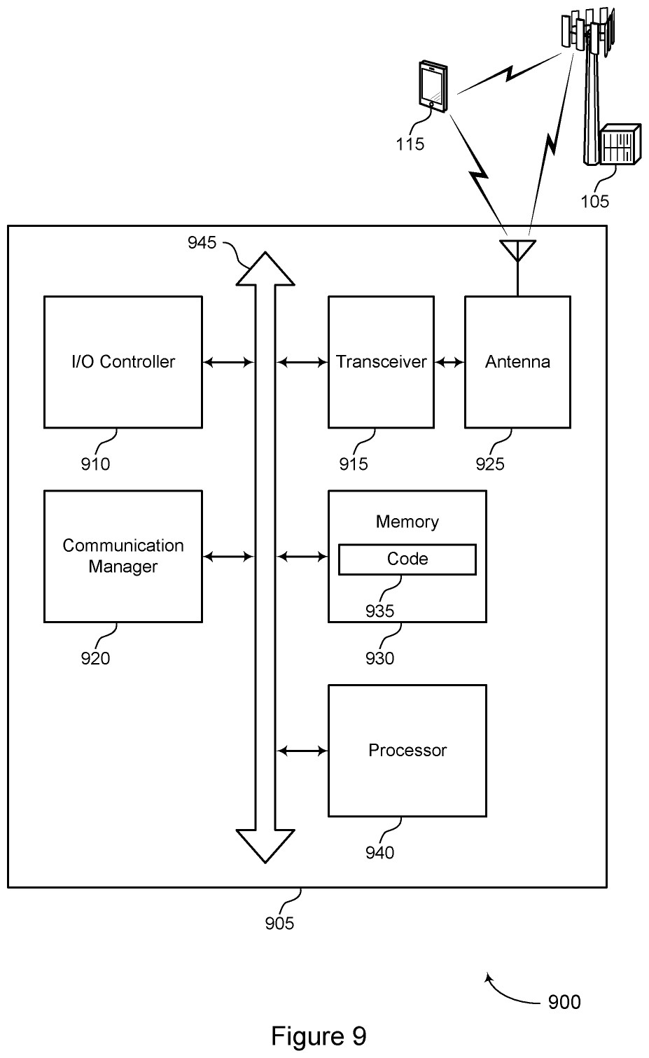

FIG. 9 shows a diagram of a system 900 including a device 905 that supports PDU session establishment via user plane signaling in accordance with one or more aspects of the present disclosure. The device 905 may be an example of or include the components of a device 605, a device 705, or a UE 115 as described herein. The device 905 may communicate (for example, wirelessly) with one or more network entities 105, one or more UEs 115, or any combination thereof. The device 905 may include components for bi-directional voice and data communication including components for transmitting and receiving communication, such as a communication manager 920, an input/output (I/O) controller 910, a transceiver 915, an antenna 925, at least one memory 930, code 935, and at least one processor 940. These components may be in electronic communication or otherwise coupled (for example, operatively, communicatively, functionally, electronically, electrically) via one or more buses (for example, a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (for example, when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (for example, the at least one memory 930) to cause the device 905 to perform various functions (for example, functions or tasks supporting PDU session establishment via user plane signaling). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communication manager 920 may support wireless communication in accordance with examples as disclosed herein. For example, the communication manager 920 is capable of, configured to, or operable to support a means for receiving first information indicative of a first IP address. The communication manager 920 is capable of, configured to, or operable to support a means for transmitting a NAS request that indicates the first IP address to a core network service to establish a PDU session using a user plane protocol stack. The communication manager 920 is capable of, configured to, or operable to support a means for receiving, from the core network service and the user plane protocol stack, a NAS response including second information indicative of a second IP address. The communication manager 920 is capable of, configured to, or operable to support a means for transmitting NAS information that indicates the first IP address to the core network service using the user plane protocol stack, and first data information associated with the PDU session that indicates the second IP address using the user plane protocol stack.

By including or configuring the communication manager 920 in accordance with examples as described herein, the device 905 may support techniques for improved communication reliability, reduced latency, and improved coordination between devices.

In some examples, the communication manager 920 may be configured to perform various operations (for example, receiving, monitoring, transmitting) using or otherwise in cooperation with the transceiver 915, the one or more antennas 925, or any combination thereof. Although the communication manager 920 is illustrated as a separate component, in some examples, one or more functions described with reference to the communication manager 920 may be supported by or performed by the at least one processor 940, the at least one memory 930, the code 935, or any combination thereof. For example, the code 935 may include instructions executable by the at least one processor 940 to cause the device 905 to perform various aspects of PDU session establishment via user plane signaling as described herein, or the at least one processor 940 and the at least one memory 930 may be otherwise configured to, individually or collectively, perform or support such operations.

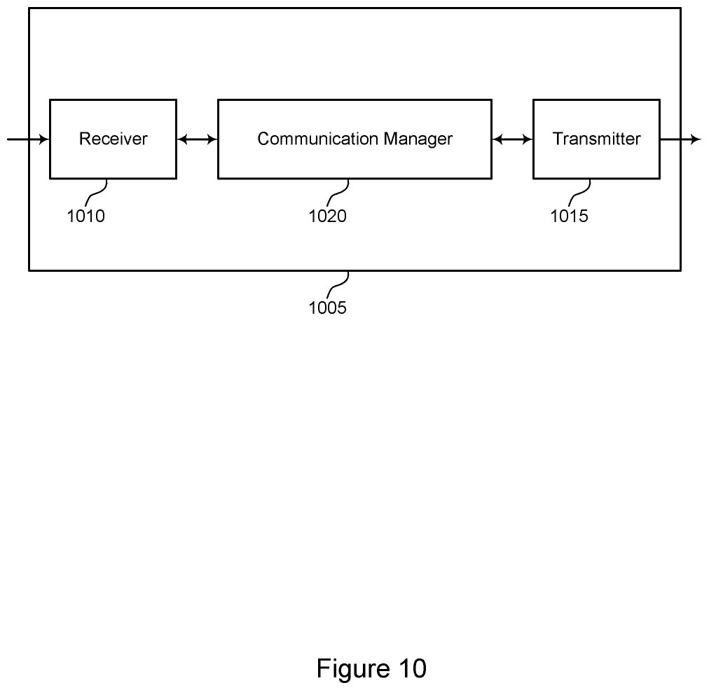

FIG. 10 shows a block diagram of a device 1005 that supports PDU session establishment via user plane signaling in accordance with one or more aspects of the present disclosure. The device 1005 may be an example of aspects of a network entity 105 as described herein. The device 1005 may include a receiver 1010, a transmitter 1015, and a communication manager 1020. The device 1005, or one or more components of the device 1005 (for example, the receiver 1010, the transmitter 1015, and the communication manager 1020), may include at least one processor, which may be coupled with at least one memory, to, individually or collectively, support or enable the described techniques. Each of these components may be in communication with one another (for example, via one or more buses).

The receiver 1010 may provide a means for obtaining (for example, receiving, determining, identifying) information such as user data, control information, or any combination thereof (for example, I/Q samples, symbols, packets, PDUs, service data units) associated with various channels (for example, control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (for example, electrical, fiber optic) interfaces, wireless interfaces, or any combination thereof.

The transmitter 1015 may provide a means for outputting (for example, transmitting, providing, conveying, sending) information generated by other components of the device 1005. For example, the transmitter 1015 may output information such as user data, control information, or any combination thereof (for example, I/Q samples, symbols, packets, PDUs, service data units) associated with various channels (for example, control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (for example, electrical, fiber optic) interfaces, wireless interfaces, or any combination thereof. In some examples, the transmitter 1015 and the receiver 1010 may be co-located in a transceiver, which may include or be coupled with a modem.

The communication manager 1020, the receiver 1010, the transmitter 1015, or various combinations thereof or various components thereof may be examples of means for performing various aspects of PDU session establishment via user plane signaling as described herein. For example, the communication manager 1020, the receiver 1010, the transmitter 1015, or various combinations or components thereof may be capable of performing one or more of the functions described herein.

In some examples, the communication manager 1020, the receiver 1010, the transmitter 1015, or various combinations or components thereof may be implemented in hardware (for example, in communication management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

Additionally, or alternatively, the communication manager 1020, the receiver 1010, the transmitter 1015, or various combinations or components thereof may be implemented in code (for example, as communication management software or firmware) executed by at least one processor. If implemented in code executed by at least one processor, the functions of the communication manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communication manager 1020 may be configured to perform various operations (for example, receiving, obtaining, monitoring, outputting, transmitting) using or otherwise in cooperation with the receiver 1010, the transmitter 1015, or both. For example, the communication manager 1020 may receive information from the receiver 1010, send information to the transmitter 1015, or be integrated in combination with the receiver 1010, the transmitter 1015, or both to obtain information, output information, or perform various other operations as described herein.

The communication manager 1020 may support wireless communication in accordance with examples as disclosed herein. For example, the communication manager 1020 is capable of, configured to, or operable to support a means for transmitting first information indicative of a first IP address to a UE. The communication manager 1020 is capable of, configured to, or operable to support a means for receiving, from the UE using a user plane protocol stack, a first PDU including the first IP address. The communication manager 1020 is capable of, configured to, or operable to support a means for transmitting, to the UE, a second PDU including the first IP address. The communication manager 1020 is capable of, configured to, or operable to support a means for receiving, from a core network entity, a second IP address and session tunnel information for a session tunnel for the UE. The communication manager 1020 is capable of, configured to, or operable to support a means for receiving, from the UE using the user plane protocol stack, a third PDU including the second IP address.

By including or configuring the communication manager 1020 in accordance with examples as described herein, the device 1005 (for example, at least one processor controlling or otherwise coupled with the receiver 1010, the transmitter 1015, the communication manager 1020, or a combination thereof) may support techniques for reduced processing and reduced power consumption.

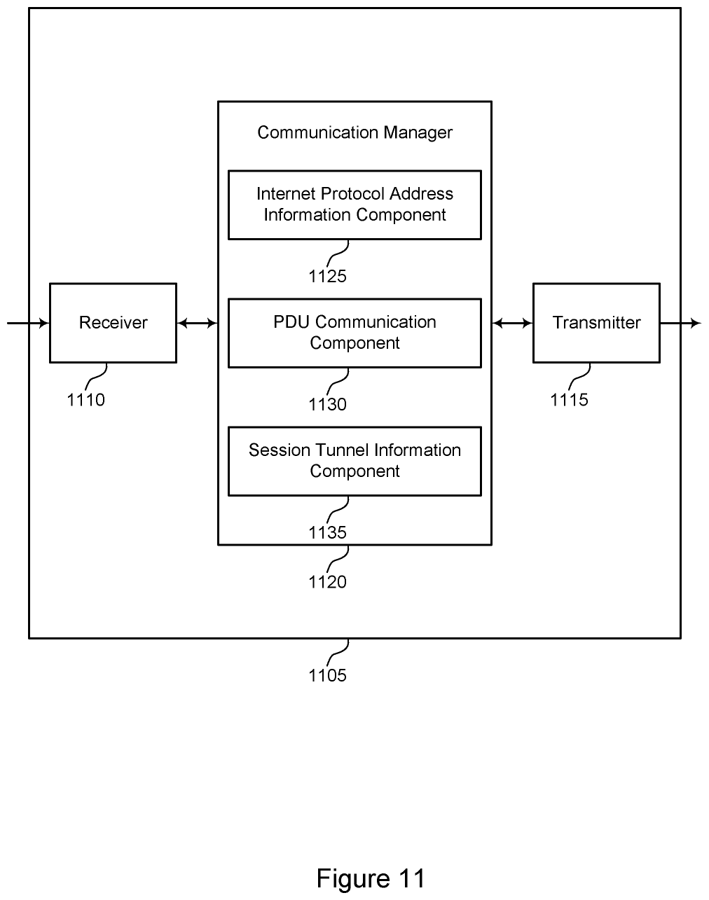

FIG. 11 shows a block diagram of a device 1105 that supports PDU session establishment via user plane signaling in accordance with one or more aspects of the present disclosure. The device 1105 may be an example of aspects of a device 1005 or a network entity 105 as described herein. The device 1105 may include a receiver 1110, a transmitter 1115, and a communication manager 1120. The device 1105, or one of more components of the device 1105 (for example, the receiver 1110, the transmitter 1115, and the communication manager 1120), may include at least one processor, which may be coupled with at least one memory, to support the described techniques. Each of these components may be in communication with one another (for example, via one or more buses).

The receiver 1110 may provide a means for obtaining (for example, receiving, determining, identifying) information such as user data, control information, or any combination thereof (for example, I/Q samples, symbols, packets, PDUs, service data units) associated with various channels (for example, control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (for example, electrical, fiber optic) interfaces, wireless interfaces, or any combination thereof.

The transmitter 1115 may provide a means for outputting (for example, transmitting, providing, conveying, sending) information generated by other components of the device 1105. For example, the transmitter 1115 may output information such as user data, control information, or any combination thereof (for example, I/Q samples, symbols, packets, PDUs, service data units) associated with various channels (for example, control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (for example, electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of PDU session establishment via user plane signaling as described herein. For example, the communication manager 1120 may include an IP address information component 1125, a PDU communication component 1130, a session tunnel information component 1135, or any combination thereof. In some examples, the communication manager 1120, or various components thereof, may be configured to perform various operations (for example, receiving, obtaining, monitoring, outputting, transmitting) using or otherwise in cooperation with the receiver 1110, the transmitter 1115, or both. For example, the communication manager 1120 may receive information from the receiver 1110, send information to the transmitter 1115, or be integrated in combination with the receiver 1110, the transmitter 1115, or both to obtain information, output information, or perform various other operations as described herein.

The communication manager 1120 may support wireless communication in accordance with examples as disclosed herein. The IP address information component 1125 is capable of, configured to, or operable to support a means for transmitting first information indicative of a first IP address to a UE. The PDU communication component 1130 is capable of, configured to, or operable to support a means for receiving, from the UE using a user plane protocol stack, a first PDU including the first IP address. The PDU communication component 1130 is capable of, configured to, or operable to support a means for transmitting, to the UE, a second PDU including the first IP address. The session tunnel information component 1135 is capable of, configured to, or operable to support a means for receiving, from a core network entity, a second IP address and session tunnel information for a session tunnel for the UE. The PDU communication component 1130 is capable of, configured to, or operable to support a means for receiving, from the UE using the user plane protocol stack, a third PDU including the second IP address.

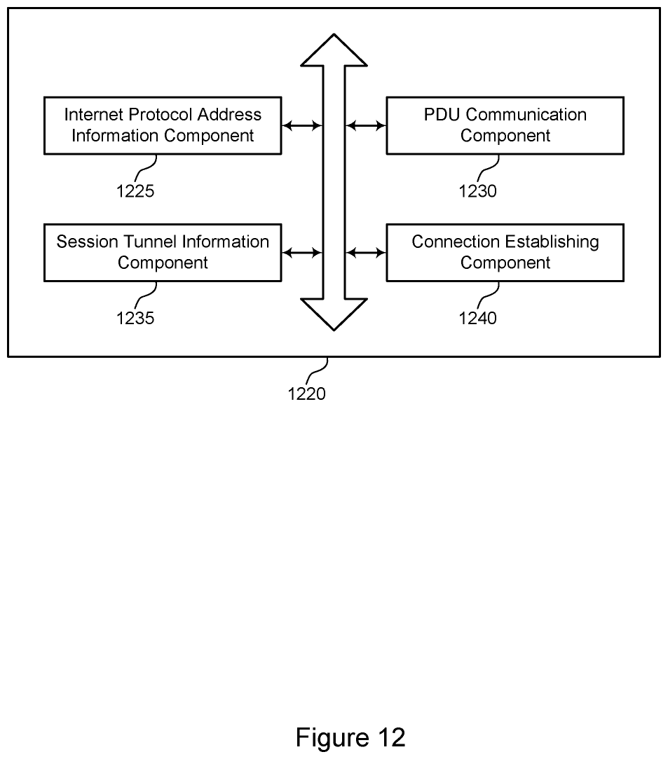

FIG. 12 shows a block diagram of a communication manager 1220 that supports PDU session establishment via user plane signaling in accordance with one or more aspects of the present disclosure. The communication manager 1220, or various components thereof, may be an example of means for performing various aspects of PDU session establishment via user plane signaling as described herein. For example, the communication manager 1220 may include an IP address information component 1225, a PDU communication component 1230, a session tunnel information component 1235, a connection establishing component 1240, or any combination thereof. Each of these components, or components or subcomponents thereof (for example, one or more processors, one or more memories), may communicate, directly or indirectly, with one another (for example, via one or more buses) which may include communication within a protocol layer of a protocol stack, communication associated with a logical channel of a protocol stack (for example, between protocol layers of a protocol stack, within a device, component, or virtualized component associated with a network entity 105, between devices, components, or virtualized components associated with a network entity 105), or any combination thereof.

The communication manager 1220 may support wireless communication in accordance with examples as disclosed herein. The IP address information component 1225 is capable of, configured to, or operable to support a means for transmitting first information indicative of a first IP address to a UE. The PDU communication component 1230 is capable of, configured to, or operable to support a means for receiving, from the UE using a user plane protocol stack, a first PDU including the first IP address. In some examples, the PDU communication component 1230 is capable of, configured to, or operable to support a means for transmitting, to the UE, a second PDU including the first IP address. The session tunnel information component 1235 is capable of, configured to, or operable to support a means for receiving, from a core network entity, a second IP address and session tunnel information for a session tunnel for the UE. In some examples, the PDU communication component 1230 is capable of, configured to, or operable to support a means for receiving, from the UE using the user plane protocol stack, a third PDU including the second IP address.

In some examples, the PDU communication component 1230 is capable of, configured to, or operable to support a means for receiving, from the session tunnel, a fourth PDU including the second IP address. In some examples, the PDU communication component 1230 is capable of, configured to, or operable to support a means for transmitting the fourth PDU to the UE using the user plane protocol stack in accordance with the second IP address.

In some examples, the PDU communication component 1230 is capable of, configured to, or operable to support a means for outputting the first PDU to a core network service in accordance with the first PDU including the first IP address.

In some examples, the PDU communication component 1230 is capable of, configured to, or operable to support a means for obtaining, from a core network service, the second PDU including the first IP address.

In some examples, the PDU communication component 1230 is capable of, configured to, or operable to support a means for outputting, to the session tunnel, the third PDU in accordance with the second IP address.

In some examples, the first PDU and the third PDU are received via a first wireless channel, and the second PDU is transmitted via the first wireless channel.

In some examples, the first PDU is received with a first channel identifier, the second PDU is transmitted with the first channel identifier, and the third PDU is received with a second channel identifier.

In some examples, the PDU communication component 1230 is capable of, configured to, or operable to support a means for outputting the first PDU to the core network entity in accordance with the first channel identifier. In some examples, the PDU communication component 1230 is capable of, configured to, or operable to support a means for outputting, the third PDU to the session tunnel in accordance with the second channel identifier.

In some examples, the first information is indicative of the first channel identifier.

In some examples, the PDU communication component 1230 is capable of, configured to, or operable to support a means for transmitting, in response to the second PDU, a fifth PDU that indicates the second channel identifier.

In some examples, the first channel identifier is a logical channel identifier, a radio link control channel identifier, an adaptation layer identifier, a radio link control entity identifier, a packet data convergence protocol entity identifier, or a layer two entity identifier, or any combination thereof.

In some examples, the first information is indicative of a first channel identifier associated with NAS signaling and a second channel identifier associated with a PDU transfer.

In some examples, the connection establishing component 1240 is capable of, configured to, or operable to support a means for receiving, via a connection establishing procedure, an indication of a UE identifier of the UE. In some examples, the connection establishing component 1240 is capable of, configured to, or operable to support a means for transmitting, via the connection establishing procedure, an indication of a network entity identifier of a network entity associated with the user plane protocol stack.

In some examples, the first information is indicative of a first channel identifier associated with NAS signaling and a second channel identifier associated with a PDU transfer.

In some examples, the user plane protocol stack includes a physical layer, a medium access control sub-layer, a radio link control sub-layer, a packet data convergence protocol sub-layer, a service data adaptation protocol sub-layer, or a security sub-layer, or any combination thereof.

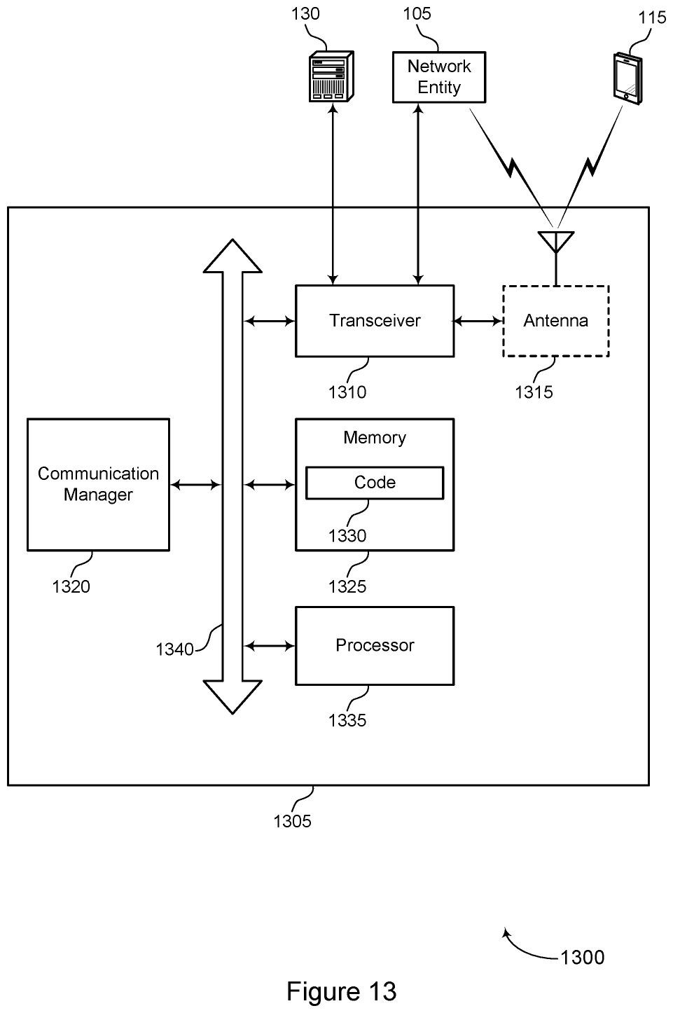

FIG. 13 shows a diagram of a system 1300 including a device 1305 that supports PDU session establishment via user plane signaling in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communication over one or more wired interfaces, over one or more wireless interfaces, or any combination thereof. The device 1305 may include components that support outputting and obtaining communication, such as a communication manager 1320, a transceiver 1310, an antenna 1315, at least one memory 1325, code 1330, and at least one processor 1335. These components may be in electronic communication or otherwise coupled (for example, operatively, communicatively, functionally, electronically, electrically) via one or more buses (for example, a bus 1340).

The transceiver 1310 may support bi-directional communication via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (for example, concurrently). The transceiver 1310 may also include a modem to modulate signals, to provide the modulated signals for transmission (for example, by one or more antennas 1315, by a wired transmitter), to receive modulated signals (for example, from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (for example, the at least one processor 1335, the at least one memory 1325, or both), may be included in a chip or chip assembly that is installed in the device 1305. In some examples, the transceiver 1310 may be operable to support communication via one or more communication links (for example, a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (for example, when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (for example, a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (for example, one or more of the at least one memory 1325) to cause the device 1305 to perform various functions (for example, functions or tasks supporting PDU session establishment via user plane signaling). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (for example, one or more physical nodes and supporting software such as operating systems, virtual machines, or container instances) that may host the functions (for example, by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communication of (for example, within) a protocol layer of a protocol stack. In some examples, a bus 1340 may support communication associated with a logical channel of a protocol stack (for example, between protocol layers of a protocol stack), which may include communication performed within a component of the device 1305, or between different components of the device 1305 that may be co-located or located in different locations (for example, where the device 1305 may refer to a system in which one or more of the communication manager 1320, the transceiver 1310, the at least one memory 1325, the code 1330, and the at least one processor 1335 may be located in one of the different components or divided between different components).

In some examples, the communication manager 1320 may manage aspects of communication with a core network 130 (for example, via one or more wired or wireless backhaul links). For example, the communication manager 1320 may manage the transfer of data communication for client devices, such as one or more UEs 115. In some examples, the communication manager 1320 may manage communication with other network entities 105, and may include a controller or scheduler for controlling communication with UEs 115 in cooperation with other network entities 105. In some examples, the communication manager 1320 may support an X2 interface within an LTE/LTE-A wireless communication network technology to provide communication between network entities 105.

The communication manager 1320 may support wireless communication in accordance with examples as disclosed herein. For example, the communication manager 1320 is capable of, configured to, or operable to support a means for transmitting first information indicative of a first IP address to a UE. The communication manager 1320 is capable of, configured to, or operable to support a means for receiving, from the UE using a user plane protocol stack, a first PDU including the first IP address. The communication manager 1320 is capable of, configured to, or operable to support a means for transmitting, to the UE, a second PDU including the first IP address. The communication manager 1320 is capable of, configured to, or operable to support a means for receiving, from a core network entity, a second IP address and session tunnel information for a session tunnel for the UE. The communication manager 1320 is capable of, configured to, or operable to support a means for receiving, from the UE using the user plane protocol stack, a third PDU including the second IP address.

By including or configuring the communication manager 1320 in accordance with examples as described herein, the device 1305 may support techniques for improved communication reliability, reduced latency, and improved coordination between devices.

In some examples, the communication manager 1320 may be configured to perform various operations (for example, receiving, obtaining, monitoring, outputting, transmitting) using or otherwise in cooperation with the transceiver 1310, the one or more antennas 1315 (for example, where applicable), or any combination thereof. Although the communication manager 1320 is illustrated as a separate component, in some examples, one or more functions described with reference to the communication manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of PDU session establishment via user plane signaling as described herein, or the at least one processor 1335 and the at least one memory 1325 may be otherwise configured to, individually or collectively, perform or support such operations.

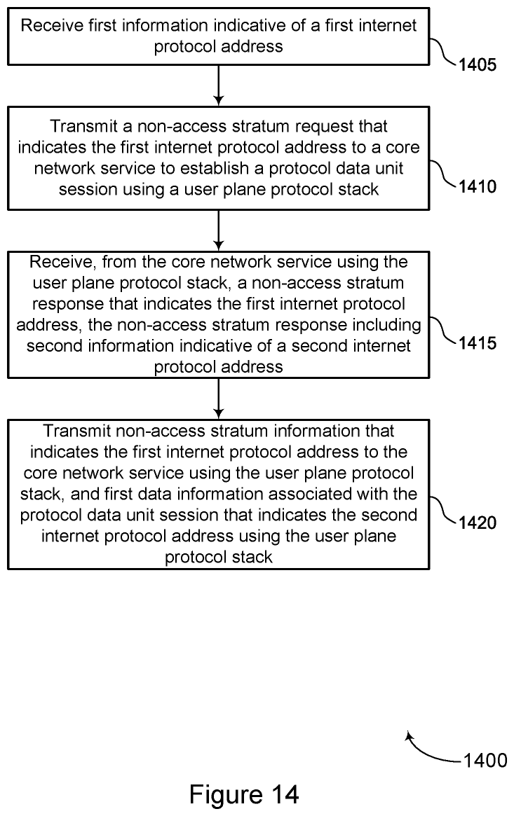

FIG. 14 shows a flowchart illustrating a method 1400 that supports PDU session establishment via user plane signaling in accordance with aspects of the present disclosure. The operations of the method 1400 may be implemented by a UE or its components as described herein. For example, the operations of the method 1400 may be performed by a UE 115 as described with reference to FIGS. 1-9. In some examples, a UE may execute a set of instructions to control the functional elements of the UE to perform the described functions. Additionally, or alternatively, the UE may perform aspects of the described functions using special-purpose hardware.

At 1405, the method may include receiving first information indicative of a first IP address. The operations of block 1405 may be performed in accordance with examples as disclosed herein. In some examples, aspects of the operations of 1405 may be performed by an IP address information component 825 as described with reference to FIG. 8.

At 1410, the method may include transmitting a NAS request that indicates the first IP address to a core network service to establish a PDU session using a user plane protocol stack. The operations of block 1410 may be performed in accordance with examples as disclosed herein. In some examples, aspects of the operations of 1410 may be performed by a NAS request component 830 as described with reference to FIG. 8.

At 1415, the method may include receiving, from the core network service using the user plane protocol stack, a NAS response that indicates the first IP address, the NAS response including second information indicative of a second IP address. The operations of block 1415 may be performed in accordance with examples as disclosed herein. In some examples, aspects of the operations of 1415 may be performed by a NAS response component 835 as described with reference to FIG. 8.

At 1420, the method may include transmitting NAS information that indicates the first IP address to the core network service using the user plane protocol stack, and first data information associated with the PDU session that indicates the second IP address using the user plane protocol stack. The operations of block 1420 may be performed in accordance with examples as disclosed herein. In some examples, aspects of the operations of 1420 may be performed by a PDU communication component 840 as described with reference to FIG. 8.

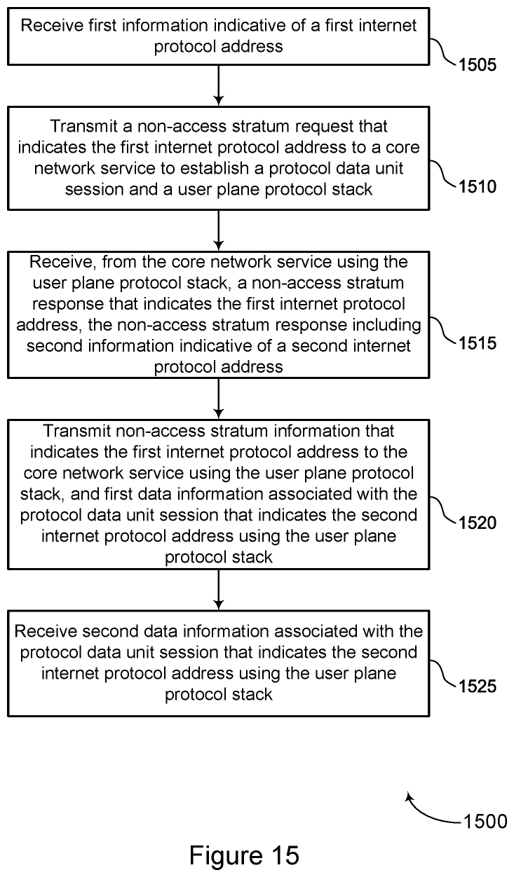

FIG. 15 shows a flowchart illustrating a method 1500 that supports PDU session establishment via user plane signaling in accordance with aspects of the present disclosure. The operations of the method 1500 may be implemented by a UE or its components as described herein. For example, the operations of the method 1500 may be performed by a UE 115 as described with reference to FIGS. 1-9. In some examples, a UE may execute a set of instructions to control the functional elements of the UE to perform the described functions. Additionally, or alternatively, the UE may perform aspects of the described functions using special-purpose hardware.

At 1505, the method may include receiving first information indicative of a first IP address. The operations of block 1505 may be performed in accordance with examples as disclosed herein. In some examples, aspects of the operations of 1505 may be performed by an IP address information component 825 as described with reference to FIG. 8.

At 1510, the method may include transmitting a NAS request that indicates the first IP address to a core network service to establish a PDU session using a user plane protocol stack. The operations of block 1510 may be performed in accordance with examples as disclosed herein. In some examples, aspects of the operations of 1510 may be performed by a NAS request component 830 as described with reference to FIG. 8.

At 1515, the method may include receiving, from the core network service using the user plane protocol stack, a NAS response that indicates the first IP address, the NAS response including second information indicative of a second IP address. The operations of block 1515 may be performed in accordance with examples as disclosed herein. In some examples, aspects of the operations of 1515 may be performed by a NAS response component 835 as described with reference to FIG. 8.

At 1520, the method may include transmitting NAS information that indicates the first IP address to the core network service using the user plane protocol stack, and first data information associated with the PDU session that indicates the second IP address using the user plane protocol stack. The operations of block 1520 may be performed in accordance with examples as disclosed herein. In some examples, aspects of the operations of 1520 may be performed by a PDU communication component 840 as described with reference to FIG. 8.

At 1525, the method may include receiving second data information associated with the PDU session that indicates the second IP address using the user plane protocol stack. The operations of block 1525 may be performed in accordance with examples as disclosed herein. In some examples, aspects of the operations of 1525 may be performed by a data signaling component 845 as described with reference to FIG. 8.

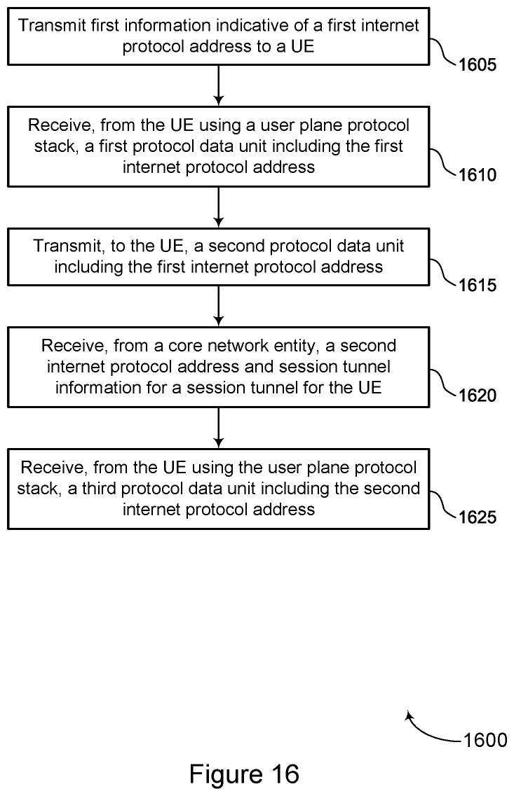

FIG. 16 shows a flowchart illustrating a method 1600 that supports PDU session establishment via user plane signaling in accordance with aspects of the present disclosure. The operations of the method 1600 may be implemented by a network entity or its components as described herein. For example, the operations of the method 1600 may be performed by a network entity as described with reference to FIGS. 1-5 and 10-13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting first information indicative of a first IP address to a UE. The operations of block 1605 may be performed in accordance with examples as disclosed herein. In some examples, aspects of the operations of 1605 may be performed by an IP address information component 1225 as described with reference to FIG. 12.

At 1610, the method may include receiving, from the UE using a user plane protocol stack, a first PDU including the first IP address. The operations of block 1610 may be performed in accordance with examples as disclosed herein. In some examples, aspects of the operations of 1610 may be performed by a PDU communication component 1230 as described with reference to FIG. 12.

At 1615, the method may include transmitting, to the UE, a second PDU including the first IP address. The operations of block 1615 may be performed in accordance with examples as disclosed herein. In some examples, aspects of the operations of 1615 may be performed by a PDU communication component 1230 as described with reference to FIG. 12.

At 1620, the method may include receiving, from a core network entity, a second IP address and session tunnel information for a session tunnel for the UE. The operations of block 1620 may be performed in accordance with examples as disclosed herein. In some examples, aspects of the operations of 1620 may be performed by a session tunnel information component 1235 as described with reference to FIG. 12.

At 1625, the method may include receiving, from the UE using the user plane protocol stack, a third PDU including the second IP address. The operations of block 1625 may be performed in accordance with examples as disclosed herein. In some examples, aspects of the operations of 1625 may be performed by a PDU communication component 1230 as described with reference to FIG. 12.

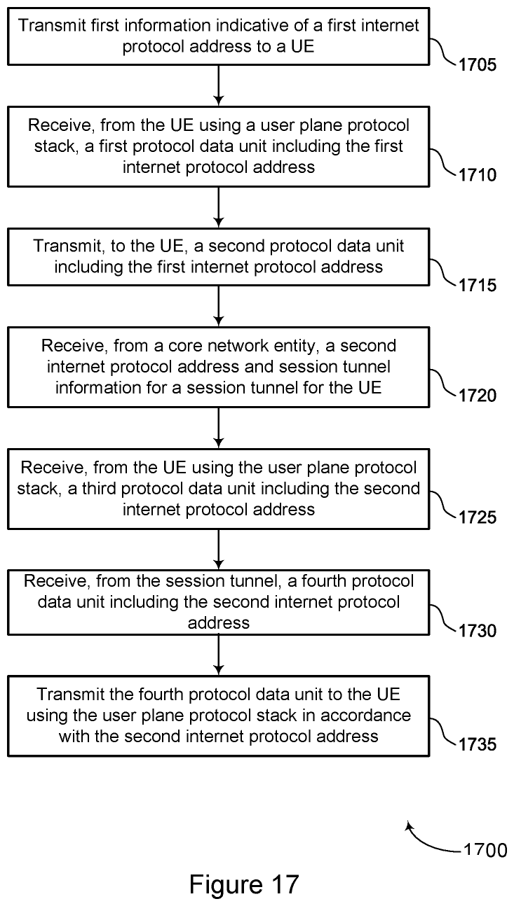

FIG. 17 shows a flowchart illustrating a method 1700 that supports PDU session establishment via user plane signaling in accordance with aspects of the present disclosure. The operations of the method 1700 may be implemented by a network entity or its components as described herein. For example, the operations of the method 1700 may be performed by a network entity as described with reference to FIGS. 1-5 and 10-13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting first information indicative of a first IP address to a UE. The operations of block 1705 may be performed in accordance with examples as disclosed herein. In some examples, aspects of the operations of 1705 may be performed by an IP address information component 1225 as described with reference to FIG. 12.

At 1710, the method may include receiving, from the UE using a user plane protocol stack, a first PDU including the first IP address. The operations of block 1710 may be performed in accordance with examples as disclosed herein. In some examples, aspects of the operations of 1710 may be performed by a PDU communication component 1230 as described with reference to FIG. 12.

At 1715, the method may include transmitting, to the UE, a second PDU including the first IP address. The operations of block 1715 may be performed in accordance with examples as disclosed herein. In some examples, aspects of the operations of 1715 may be performed by a PDU communication component 1230 as described with reference to FIG. 12.

At 1720, the method may include receiving, from a core network entity, a second IP address and session tunnel information for a session tunnel for the UE. The operations of block 1720 may be performed in accordance with examples as disclosed herein. In some examples, aspects of the operations of 1720 may be performed by a session tunnel information component 1235 as described with reference to FIG. 12.

At 1725, the method may include receiving, from the UE using the user plane protocol stack, a third PDU including the second IP address. The operations of block 1725 may be performed in accordance with examples as disclosed herein. In some examples, aspects of the operations of 1725 may be performed by a PDU communication component 1230 as described with reference to FIG. 12.

At 1730, the method may include receiving, from the session tunnel, a fourth PDU including the second IP address. The operations of block 1730 may be performed in accordance with examples as disclosed herein. In some examples, aspects of the operations of 1730 may be performed by a PDU communication component 1230 as described with reference to FIG. 12.

At 1735, the method may include transmitting the fourth PDU to the UE using the user plane protocol stack in accordance with the second IP address. The operations of block 1735 may be performed in accordance with examples as disclosed herein. In some examples, aspects of the operations of 1735 may be performed by a PDU communication component 1230 as described with reference to FIG. 12.

The following provides an overview of aspects of the present disclosure:

Aspect 1: A method for wireless communications by a UE, comprising: receiving first information indicative of a first internet protocol address; transmitting a non-access stratum request that indicates the first internet protocol address to a core network service to establish a protocol data unit session using a user plane protocol stack; receiving, from the core network service using the user plane protocol stack, a non-access stratum response that indicates the first internet protocol address, the non-access stratum response comprising second information indicative of a second internet protocol address; and transmitting non-access stratum information that indicates the first internet protocol address to the core network service using the user plane protocol stack, and first data information associated with the protocol data unit session that indicates the second internet protocol address using the user plane protocol stack.

Aspect 2: The method of aspect 1, further comprising: receiving second data information associated with the protocol data unit session that indicates the second internet protocol address using the user plane protocol stack.

Aspect 3: The method of any of aspects 1 through 2, wherein the first data information and the non-access stratum information are transmitted using a same wireless channel.

Aspect 4: The method of any of aspects 1 through 3, wherein a first wireless channel carrying the non-access stratum request associated with non-access stratum signaling is associated with a first channel identifier.

Aspect 5: The method of aspect 4, wherein the first information indicates the first channel identifier with the first internet protocol address.

Aspect 6: The method of any of aspects 4 through 5, wherein the first channel identifier is a logical channel identifier, a radio link control channel identifier, an adaptation layer identifier, a radio link control entity identifier, a packet data convergence protocol entity identifier, or a layer two entity identifier, or any combination thereof.

Aspect 7: The method of any of aspects 4 through 6, further comprising: receiving, in response to the non-access stratum request, third information that indicates a second channel identifier associated with the protocol data unit session.

Aspect 8: The method of aspect 7, wherein a second wireless channel carrying the first data information is associated with the second channel identifier.

Aspect 9: The method of any of aspects 7 through 8, further comprising: receiving, using the user plane protocol stack, second data information associated with the protocol data unit session, wherein a second wireless channel carrying the second data information is associated with the second channel identifier.

Aspect 10: The method of any of aspects 1 through 9, wherein the first information is indicative of a first channel identifier associated with non-access stratum signaling and a second channel identifier associated with a protocol data unit transfer.

Aspect 11: The method of any of aspects 1 through 10, wherein the non-access stratum request comprises fourth information indicative of a first identifier of a network entity associated with the protocol data unit session, a second identifier of the UE, or both.

Aspect 12: The method of any of aspects 1 through 11, wherein the non-access stratum response comprises fifth information indicative of a protocol data unit session identifier associated with the protocol data unit session.

Aspect 13: The method of any of aspects 1 through 12, further comprising: transmitting, via a connection establishing procedure, an indication of a UE identifier of the UE; and receiving, via the connection establishing procedure, an indication of a network entity identifier of a network entity associated with the user plane protocol stack.

Aspect 14: A method for wireless communications by a network node, comprising: transmitting first information indicative of a first internet protocol address to a UE; receiving, from the UE using a user plane protocol stack, a first protocol data unit comprising the first internet protocol address; transmitting, to the UE, a second protocol data unit comprising the first internet protocol address; receiving, from a core network entity, a second internet protocol address and session tunnel information for a session tunnel for the UE; and receiving, from the UE using the user plane protocol stack, a third protocol data unit comprising the second internet protocol address.

Aspect 15: The method of aspect 14, further comprising: receiving, from the session tunnel, a fourth protocol data unit comprising the second internet protocol address; and transmitting the fourth protocol data unit to the UE using the user plane protocol stack in accordance with the second internet protocol address.

Aspect 16: The method of any of aspects 14 through 15, further comprising: outputting the first protocol data unit to a core network service in accordance with the first protocol data unit comprising the first internet protocol address.

Aspect 17: The method of any of aspects 14 through 16, further comprising: obtaining, from a core network service, the second protocol data unit comprising the first internet protocol address.

Aspect 18: The method of any of aspects 14 through 17, further comprising: outputting, to the session tunnel, the third protocol data unit in accordance with the second internet protocol address.

Aspect 19: The method of any of aspects 14 through 18, wherein the first protocol data unit and the third protocol data unit are received via a first wireless channel, and the second protocol data unit is transmitted via the first wireless channel.

Aspect 20: The method of any of aspects 14 through 19, wherein the first protocol data unit is received with a first channel identifier, the second protocol data unit is transmitted with the first channel identifier, and the third protocol data unit is received with a second channel identifier.

Aspect 21: The method of aspect 20, further comprising: outputting the first protocol data unit to the core network entity in accordance with the first channel identifier; and outputting, the third protocol data unit to the session tunnel in accordance with the second channel identifier.

Aspect 22: The method of any of aspects 20 through 21, wherein the first information is indicative of the first channel identifier.

Aspect 23: The method of any of aspects 20 through 22, further comprising:

transmitting, in response to the second protocol data unit, a fifth protocol data unit that indicates the second channel identifier.

Aspect 24: The method of any of aspects 20 through 23, wherein the first channel identifier is a logical channel identifier, a radio link control channel identifier, an adaptation layer identifier, a radio link control entity identifier, a packet data convergence protocol entity identifier, or a layer two entity identifier, or any combination thereof.

Aspect 25: The method of any of aspects 14 through 24, wherein the first information is indicative of a first channel identifier associated with non-access stratum signaling and a second channel identifier associated with a protocol data unit transfer.

Aspect 26: The method of any of aspects 14 through 25, further comprising: receiving, via a connection establishing procedure, an indication of a UE identifier of the UE; and transmitting, via the connection establishing procedure, an indication of a network entity identifier of a network entity associated with the user plane protocol stack.

Aspect 27: The method of any of aspects 14 through 26, wherein the first information is indicative of a first channel identifier associated with non-access stratum signaling and a second channel identifier associated with a protocol data unit transfer.

Aspect 28: The method of any of aspects 14 through 27, wherein the user plane protocol stack comprises a physical layer, a medium access control sub-layer, a radio link control sub-layer, a packet data convergence protocol sub-layer, a service data adaptation protocol sub-layer, or a security sub-layer, or any combination thereof.

Aspect 29: A UE for wireless communications, comprising a processing system that includes processor circuitry and memory circuitry that stores code, the processing system configured to cause the UE to perform a method of any of aspects 1 through 13.

Aspect 30: A UE for wireless communications, comprising at least one means for performing a method of any of aspects 1 through 13.

Aspect 31: A non-transitory computer-readable medium storing code for wireless communications, the code comprising instructions executable by one or more processors to perform a method of any of aspects 1 through 13.

Aspect 32: A network node for wireless communications, comprising a processing system that includes processor circuitry and memory circuitry that stores code, the processing system configured to cause the network node to perform a method of any of aspects 14 through 28.

Aspect 33: A network node for wireless communications, comprising at least one means for performing a method of any of aspects 14 through 28.

Aspect 34: A non-transitory computer-readable medium storing code for wireless communications, the code comprising instructions executable by one or more processors to perform a method of any of aspects 14 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (in other words, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (for example, receiving information), accessing (for example, accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive first information indicative of a first internet protocol address;
transmit a non-access stratum request that indicates the first internet protocol address to a core network service to establish a protocol data unit session using a user plane protocol stack;
receive, from the core network service using the user plane protocol stack, a non-access stratum response that indicates the first internet protocol address, the non-access stratum response comprising second information indicative of a second internet protocol address; and
transmit non-access stratum information that indicates the first internet protocol address to the core network service using the user plane protocol stack, and first data information associated with the protocol data unit session that indicates the second internet protocol address using the user plane protocol stack.

2. The UE of claim 1, wherein the processing system is further configured to cause the UE to receive second data information associated with the protocol data unit session that indicates the second internet protocol address using the user plane protocol stack.

3. The UE of claim 1, wherein the first data information and the non-access stratum information are transmitted using a same wireless channel.

4. The UE of claim 1, wherein a first wireless channel carrying the non-access stratum request associated with non-access stratum signaling is associated with a first channel identifier.

5. The UE of claim 4, wherein the first information indicates the first channel identifier with the first internet protocol address.

6. The UE of claim 4, wherein the first channel identifier is a logical channel identifier, a radio link control channel identifier, an adaptation layer identifier, a radio link control entity identifier, a packet data convergence protocol entity identifier, or a layer two entity identifier, or any combination thereof.

7. The UE of claim 4, wherein the processing system is further configured to cause the UE to receive, in response to the non-access stratum request, third information that indicates a second channel identifier associated with the protocol data unit session.

8. The UE of claim 7, wherein a second wireless channel carrying the first data information is associated with the second channel identifier.

9. The UE of claim 7, wherein the processing system is further configured to cause the UE to receive, using the user plane protocol stack, second data information associated with the protocol data unit session, wherein a second wireless channel carrying the second data information is associated with the second channel identifier.

10. The UE of claim 1, wherein the first information is indicative of a first channel identifier associated with non-access stratum signaling and a second channel identifier associated with a protocol data unit transfer.

11. The UE of claim 1, wherein the non-access stratum request comprises fourth information indicative of a first identifier of a network entity associated with the protocol data unit session, a second identifier of the UE, or both.

12. The UE of claim 1, wherein the non-access stratum response comprises fifth information indicative of a protocol data unit session identifier associated with the protocol data unit session.

13. The UE of claim 1, wherein the processing system is further configured to cause the UE to:
transmit, via a connection establishing procedure, an indication of a UE identifier of the UE; and
receive, via the connection establishing procedure, an indication of a network entity identifier of a network entity associated with the user plane protocol stack.

14. A network node, comprising:
a processing system that includes processor circuitry and memory circuitry that stores code, the processing system configured to cause the network node to:
transmit first information indicative of a first internet protocol address to a user equipment (UE);
receive, from the UE using a user plane protocol stack, a first protocol data unit comprising the first internet protocol address;
transmit, to the UE, a second protocol data unit comprising the first internet protocol address;
receive, from a core network entity, a second internet protocol address and session tunnel information for a session tunnel for the UE; and
receive, from the UE using the user plane protocol stack, a third protocol data unit comprising the second internet protocol address.

15. The network node of claim 14, wherein the processing system is further configured to cause the network node to:
receive, from the session tunnel, a fourth protocol data unit comprising the second internet protocol address; and
transmit the fourth protocol data unit to the UE using the user plane protocol stack in accordance with the second internet protocol address.

16. The network node of claim 14, wherein the processing system is further configured to cause the network node to output the first protocol data unit to a core network service in accordance with the first protocol data unit comprising the first internet protocol address.

17. The network node of claim 14, wherein the processing system is further configured to cause the network node to obtain, from a core network service, the second protocol data unit comprising the first internet protocol address.

18. The network node of claim 14, wherein the processing system is further configured to cause the network node to output, to the session tunnel, the third protocol data unit in accordance with the second internet protocol address.

19. The network node of claim 14, wherein the first protocol data unit and the third protocol data unit are received via a first wireless channel, and the second protocol data unit is transmitted via the first wireless channel.

20. The network node of claim 14, wherein the first protocol data unit is received with a first channel identifier, the second protocol data unit is transmitted with the first channel identifier, and the third protocol data unit is received with a second channel identifier.

21. The network node of claim 20, wherein the processing system is further configured to cause the network node to:
output the first protocol data unit to the core network entity in accordance with the first channel identifier; and
output, the third protocol data unit to the session tunnel in accordance with the second channel identifier.

22. The network node of claim 20, wherein the first information is indicative of the first channel identifier.

23. The network node of claim 20, wherein the processing system is further configured to cause the network node to transmit, in response to the second protocol data unit, a fifth protocol data unit that indicates the second channel identifier.

24. The network node of claim 20, wherein the first channel identifier is a logical channel identifier, a radio link control channel identifier, an adaptation layer identifier, a radio link control entity identifier, a packet data convergence protocol entity identifier, or a layer two entity identifier, or any combination thereof.

25. The network node of claim 14, wherein the first information is indicative of a first channel identifier associated with non-access stratum signaling and a second channel identifier associated with a protocol data unit transfer.

26. The network node of claim 14, wherein the processing system is further configured to cause the network node to:
receive, via a connection establishing procedure, an indication of a UE identifier of the UE; and
transmit, via the connection establishing procedure, an indication of a network entity identifier of a network entity associated with the user plane protocol stack.

27. The network node of claim 14, wherein the first information is indicative of a first channel identifier associated with non-access stratum signaling and a second channel identifier associated with a protocol data unit transfer.

28. The network node of claim 14, wherein the user plane protocol stack comprises a physical layer, a medium access control sub-layer, a radio link control sub-layer, a packet data convergence protocol sub-layer, a service data adaptation protocol sub-layer, or a security sub-layer, or any combination thereof.

29. A method for wireless communication by a user equipment (UE), comprising:
receiving first information indicative of a first internet protocol address;
transmitting a non-access stratum request that indicates the first internet protocol address to a core network service to establish a protocol data unit session using a user plane protocol stack;
receiving, from the core network service using the user plane protocol stack, a non-access stratum response that indicates the first internet protocol address, the non-access stratum response comprising second information indicative of a second internet protocol address; and
transmitting non-access stratum information that indicates the first internet protocol address to the core network service using the user plane protocol stack, and first data information associated with the protocol data unit session that indicates the second internet protocol address using the user plane protocol stack.

30. A method for wireless communication by a network node, comprising:
transmitting first information indicative of a first internet protocol address to a user equipment (UE);
receiving, from the UE using a user plane protocol stack, a first protocol data unit comprising the first internet protocol address;
transmitting, to the UE, a second protocol data unit comprising the first internet protocol address;
receiving, from a core network entity, a second internet protocol address and session tunnel information for a session tunnel for the UE; and
receiving, from the UE using the user plane protocol stack, a third protocol data unit comprising the second internet protocol address.
